(19) United States
(12) Patent Application Publication
(10) Pub. No.: US 2026/0269222 A1
(43) Pub. Date: Sep. 10, 2026

(54) ANODE ASSEMBLY FOR A BATTERY CELL

(71) Applicant: ION STORAGE SYSTEMS, INC., Beltsville, MD (US)

(72) Inventors: Elizabeth A. SANTORI, Beltsville, MD (US); Nicholas S. HUDAK, Beltsville, MD (US); Ken MICHIE, Beltsville, MD (US); Alexander KUKAY, Beltsville, MD (US); Avi GRINBERG, Beltsville, MD (US); Connor Jackson LEACH, Beltsville, MD (US); Cory BOMBERGER, Beltsville, MD (US); Diana Marie LUTZ, Beltsville, MD (US); Mara TOLKSDORF, Beltsville, MD (US); Marissa Michelle BRADLEY, Beltsville, MD (US); Rahul JAY, Beltsville, MD (US)

(21) Appl. No.: 19/128,461

(22) PCT Filed: Nov. 9, 2023
(86) PCT No.: PCT/US2023/079201

§ 371 Date: May 8, 2025

Related U.S. Application Data
(60) Provisional application No. 63/383,040, filed on Nov. 9, 2022.

(51) Int. Cl. H01M 4/36; H01M 4/02; H01M 4/62; H01M 4/66; H01M 10/0525; H01M 10/0563; H01M 10/0566; H01M 10/0585; H01M 50/46; H01M 50/491; H01M 50/536

(52) U.S. Cl. CPC H01M 4/366; H01M 4/625; H01M 4/626; H01M 4/669; H01M 10/0563; H01M 10/0566; H01M 10/0585; H01M 50/46; H01M 50/491; H01M 50/536; H01M 2004/021; H01M 2004/027; H01M 10/0525; H01M 2300/002; H01M 2300/0025

(57) ABSTRACT

The present disclosure provides an anode assembly for a battery cell. The anode assembly comprises a separator layer, an anode layer, a deposited layer, and an anode current collector. The anode layer is at least partially disposed on the separator layer and has a first surface facing the separator layer and a second surface facing away from the separator layer. The anode layer comprises a solid-state electrolyte (SSE) having pores. The deposited layer is at least partially disposed on the second surface of the anode layer. The deposited layer comprises at least one of a conductive material and a nucleation material. The anode current collector is coupled to the deposited layer. The present disclosure also provides methods of forming an anode assembly for a battery cell.

### CROSS-REFERENCE TO RELATED APPLICATION

This application claims priority to U.S. provisional application No. 63/383,040, filed Nov. 9, 2022, the entire contents of which are incorporated herein by reference.

### FIELD OF THE INVENTION

The present invention relates to an anode assembly for a battery cell and methods of forming the same.

### BACKGROUND

Lithium (Li) metal is considered an ideal electrode (e.g., anode) material for next generation energy storage systems (e.g., batteries) due to its low reduction potential (−3.04 V as compared to a standard hydrogen electrode) and high specific capacity (3860 mAh/g). However, lithium electrodes (e.g., anodes) have a tendency to form dendrites that may permeate between an anode and cathode, thereby creating short circuits. Moreover, organic liquid electrolytes are highly flammable, creating safety concerns. As an alternative, solid-state electrolytes (SSEs) have been proposed due to their higher mechanical strength, which suppresses lithium dendrites, and their lack of flammability.

In addition, solid-state battery cell anodes (e.g., lithium-ion battery cell anodes) may be fabricated with a metal material (e.g., lithium metal) disposed on a layer. Metal materials frequently disposed on the anode layer are sensitive to environmental conditions (e.g., moisture and oxygen). This sensitivity of the metal materials and the price associated with refining battery-grade metal materials increases costs for fabrication of the battery cells, since the manufacturing process must account for sourcing, storing, and handling of the metal materials. It is preferable to form a lithium-free anode, wherein the lithium metal which forms the anode active material is generated upon the first charge of the cell from lithium originally disposed in the cathode.

As such, there remains a need to provide an improved anode assembly for a battery cell.

### SUMMARY OF THE INVENTION

In one aspect, the present invention provides an anode assembly for a battery cell. The anode assembly comprises a separator layer, an anode layer, a deposited layer, and an anode current collector. The anode layer is at least partially disposed on the separator layer and has a first surface facing the separator layer and a second surface facing away from the separator layer. The anode layer comprises a solid-state electrolyte (SSE) material having pores. The deposited layer is at least partially disposed on the second surface of the anode layer. The deposited layer comprises at least one of an electrically conductive material and a nucleation material. The anode current collector is coupled to the deposited layer.

In some embodiments, the deposited layer comprises at least one of an electrically conductive layer and a nucleation layer. The electrically conductive layer is at least partially disposed on the second surface of the anode layer and comprises the conductive material. The nucleation layer is at least partially disposed on the second surface of the anode layer and comprises the nucleation material. The anode current collector is coupled to the at least one of the electrically conductive layer and the nucleation layer.

In some embodiments, the deposited layer comprises the electrically conductive layer. In other embodiments, the deposited layer comprises the nucleation layer.

In some embodiments, deposited layer comprises the electrically conductive layer and the nucleation layer. In some embodiments, the nucleation layer is disposed between the anode layer and the electrically conductive layer. In other embodiments, the electrically conductive layer is disposed between the anode layer and the nucleation layer.

In some embodiments, the electrically conductive layer is substantially impervious to liquid. In other embodiments, the nucleation layer is substantially impervious to liquid.

In some embodiments, the anode assembly further comprises a seal layer at least partially disposed on the at least one of the electrically conductive layer and the nucleation layer. The seal layer is substantially impervious to liquid. In some embodiments, the seal layer comprises a polymer. And, in some embodiments, the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

In some embodiments, the seal layer has a thickness of from about 1 μm to about 50 μm. In other embodiments, the seal layer has a thickness of from about 1 μm to about 20 μm. In some embodiments, the seal layer has a thickness of from about 1 μm to about 10 μm. And, in some embodiments, seal layer has a thickness of from about 1 μm to about 5 μm.

In some embodiments, the seal layer couples the anode current collector to the at least one of the electrically conductive layer and the nucleation layer (e.g., by bonding the anode current collector in contact with at least one of the electrically conductive layer and the nucleation layer).

In some embodiments, electrically conductive tape couples the anode current collector to the at least one of the electrically conductive layer and the nucleation layer.

In some embodiments, the electrically conductive layer is further defined as a first electrically conductive layer, and the anode assembly further comprises a second electrically conductive layer. The second electrically conductive layer is at least partially disposed on the first electrically conductive layer and comprises a conductive material.

In some embodiments, the conductive material of the electrically conductive layer comprises a metal, a metal oxide, a metal alloy, carbon black, carbon nanotubes, graphite, graphene, amorphous carbon, or any combination thereof. In other embodiments, the electrically conductive layer is substantially free of a metal or a metal alloy that reacts with lithium metal at room temperature or forms an alloy with lithium metal at room temperature. And, in some embodiments, the conductive material of the electrically conductive layer comprises copper, nickel, titanium, stainless steel, alloys thereof, or any combination thereof.

In some embodiments, the electrically conductive layer has a thickness of from about 1 nm to about 15 μm. In other embodiments, the electrically conductive layer has a thickness of from about 1 nm to about 1 μm. In some embodiments, the electrically conductive layer has a thickness of from about 1 nm to about 500 nm. And, in some embodiments, the electrically conductive layer has a thickness of from about 1 nm to about 100 nm.

In some embodiments, the nucleation material of the nucleation layer comprises silver, gold, aluminum, bismuth, antimony, indium, zinc, gallium, nickel oxide, titanium oxide, copper oxide, zinc oxide, graphene, graphite, carbon black, or any combination thereof.

In some embodiments, the nucleation layer has a thickness of from about 1 nm to about 1 μm. In other embodiments, the nucleation layer has a thickness of from about 1 nm to about 500 nm. In some embodiments, the nucleation layer has a thickness of from about 1 nm to about 100 nm. And, in some embodiments, the nucleation layer has a thickness of from about 1 nm to about 50 nm.

In some embodiments, the separator layer is substantially free of pores. In some embodiments, the separator layer comprises a SSE material. And, in some embodiments, the SSE material of the separator layer comprises a polymer, a sulfide, an oxide, a chalcogenide, or any combination thereof.

In some embodiments, the separator layer has a thickness of from about 1 μm to about 300 μm. In some embodiments, the separator layer has a thickness of from about 1 μm to about 200 μm. In other embodiments, the separator layer has a thickness of from about 1 μm to about 100 μm. In some embodiments, the separator layer has a thickness of from about 1 μm to about 50 μm. In some embodiments, the separator layer has a thickness of from about 1 μm to about 20 μm. And, in some embodiments, the separator layer has a thickness of from about 1 μm to about 10 μm.

In some embodiments, the pores of the anode layer are substantially free of a lithium material (e.g., lithium metal).

In some embodiments, the anode layer defines a first porous region and a second porous region. The first porous region is defined between the first and second surfaces of the anode layer. The second porous region is defined between the first porous region and the second surface of the anode layer.

In some embodiments, the pores of the first porous region are substantially free of a metal material. In other embodiments, the pores of the first porous region are substantially free of a lithium material (e.g., lithium metal).

In some embodiments, at least a portion of the pores of the second porous region comprise a conductive material, a nucleation material, or any combination thereof. In some embodiments, the conductive material of the second porous region comprises a metal, a metal oxide, a metal alloy, carbon black, carbon nanotubes, graphite, graphene, amorphous carbon, or any combination thereof. And, in some embodiments, the nucleation material of the second porous region comprises silver, gold, aluminum, bismuth, antimony, indium, zinc, gallium, nickel oxide, titanium oxide, copper oxide, zinc oxide, graphene, graphite, carbon black, or any combination thereof.

In some embodiments, the anode layer has a thickness of from about 1 μm to about 500 μm. In some embodiments, the anode layer has a thickness of from about 1 μm to about 200 μm. In other embodiments, the anode layer has a thickness of from about 1 μm to about 100 μm. In some embodiments, the anode layer has a thickness of from about 1 μm to about 50 μm. And, in some embodiments, the anode layer has a thickness of from about 1 μm to about 20 μm.

In some embodiments, the anode current collector comprises a metal foil. In other embodiments, the metal foil comprises copper, nickel, titanium, alloys thereof, or any combination thereof. And, in some embodiments, the metal foil has a tab configured to connect with an external circuit.

In some embodiments, the anode current collector comprises a tab configured to connect with an external circuit.

In some embodiments, the deposited layer comprises the conductive material. In other embodiments, the deposited layer comprises the nucleation material. And, in some embodiments, the deposited layer comprises the conductive material and the nucleation material.

In some embodiments, the conductive material of the deposited layer comprises a metal, a metal oxide, a metal alloy, carbon black, carbon nanotubes, graphite, graphene, amorphous carbon, or any combination thereof. In other embodiments, the deposited layer is substantially free of a metal or a metal alloy that reacts with lithium metal at room temperature or forms an alloy with lithium metal at room temperature. And, in some embodiments, the conductive material of the deposited layer comprises copper, nickel, titanium, stainless steel, alloys thereof, or any combination thereof.

In some embodiments, the nucleation material of the deposited layer comprises silver, gold, aluminum, bismuth, antimony, indium, zinc, gallium, nickel oxide, titanium oxide, copper oxide, zinc oxide, graphene, graphite, carbon black, or any combination thereof.

In some embodiments, the deposited layer has a thickness of from about 1 nm to about 20 μm. In other embodiments, the deposited layer has a thickness of from about 1 nm to about 5 μm. In some embodiments, the deposited layer has a thickness of from about 1 nm to about 1 μm. And, in some embodiments, the deposited layer has a thickness of from about 1 nm to about 100 nm.

In some embodiments, the deposited layer is substantially impervious to liquid.

In some embodiments, the anode assembly further comprises a seal layer at least partially disposed on the deposited layer. The seal layer is substantially impervious to liquid. In some embodiments, the seal layer comprises a polymer. And, in other embodiments, the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

In some embodiments, the seal layer has a thickness of from about 1 μm to about 50 μm. In other embodiments, the seal layer has a thickness of from about 1 μm to about 20 μm. In some embodiments, the seal layer has a thickness of from about 1 μm to about 10 μm. And, in some embodiments, seal layer has a thickness of from about 1 μm to about 5 μm.

In some embodiments, the seal layer couples the anode current collector to the deposited layer (e.g., by bonding the anode current collector in contact with the deposited layer).

In some embodiments, electrically conductive tape couples the anode current collector to the deposited layer.

In another aspect, the present invention provides a battery cell. The battery cell comprises the anode assembly described herein and a cathode assembly. The cathode assembly comprises a cathode layer and a cathode current collector. The cathode layer is at least partially disposed on the separator layer of the anode assembly. The cathode current collector is coupled to the cathode layer.

In some embodiments, the battery cell further comprises a liquid comprising an electrolyte, an anolyte, a catholyte, or any combination thereof. In other embodiments, the liquid comprises a lithium salt, a linear carbonate, a cyclic carbonate, an ionic liquid, or any combination thereof.

In another aspect, the present invention provides methods of forming the anode assembly described herein.

### BRIEF DESCRIPTION OF THE DRAWINGS

The figures below are provided by way of example and are not intended to limit the scope of the claimed invention.

FIG. 1A is a cross-sectional view of a first exemplary embodiment of an anode assembly for a battery cell.

FIG. 1B is a cross-sectional view of an exemplary embodiment of a multi-layer anode assembly comprising two anode assemblies of FIG. 1A, wherein the anode assemblies share a common anode current collector.

FIG. 1C is a front view of the anode assembly of FIG. 1A.

FIG. 2 is a cross-sectional view of a second exemplary embodiment of an anode assembly for a battery cell.

FIG. 3A is a cross-sectional view of a third exemplary embodiment of an anode assembly for a battery cell.

FIG. 3B is a cross-sectional view of an exemplary embodiment of a multi-layer anode assembly comprising two anode assemblies of FIG. 3A, wherein the anode assemblies share a common seal layer.

FIG. 3C is a front view of the anode assembly of FIG. 3A.

FIG. 4A is a cross-sectional view of a fourth exemplary embodiment of an anode assembly for a battery cell.

FIG. 4B is a cross-sectional view of an exemplary embodiment of a multi-layer anode assembly comprising two anode assemblies of FIG. 4A, wherein the anode assemblies share a common anode current collector.

FIG. 4C is a front view of the anode assembly of FIG. 4A.

FIG. 5A is a cross-sectional view of a fifth exemplary embodiment of an anode assembly for a battery cell.

FIG. 5B is a cross-sectional view of an exemplary embodiment of a multi-layer anode assembly comprising two anode assemblies of FIG. 5A, wherein the anode assemblies share a common barrier film.

FIG. 5C is a front view of the anode assembly of FIG. 5A.

FIG. 6A is a cross-sectional view of a sixth exemplary embodiment of an anode assembly for a battery cell.

FIG. 6B is a cross-sectional view of an exemplary embodiment of a multi-layer anode assembly comprising two anode assemblies of FIG. 6A, wherein the anode assemblies share a common seal layer.

FIG. 6C is a front view of the anode assembly of FIG. 6A.

FIG. 7A is a cross-sectional view of a seventh exemplary embodiment of an anode assembly for a battery cell.

FIG. 7B is a cross-sectional view of an exemplary embodiment of a multi-layer anode assembly comprising two anode assemblies of FIG. 7A, wherein the anode assemblies share a common deposited layer.

FIG. 7C is a front view of the anode assembly of FIG. 7A.

FIG. 8A is a cross-sectional view of an eighth exemplary embodiment of an anode assembly for a battery cell.

FIG. 8B is a cross-sectional view of an exemplary embodiment of a multi-layer anode assembly comprising two anode assemblies of FIG. 8A, wherein the anode assemblies share a common electrically conductive layer and an anode current collector.

FIG. 8C is a front view of the anode assembly of FIG. 8A.

FIG. 9A is a cross-sectional view of a ninth exemplary embodiment of an anode assembly for a battery cell.

FIG. 9B is a cross-sectional view of an exemplary embodiment of a multi-layer anode assembly comprising two anode assemblies of FIG. 9A, wherein the anode assemblies share a common anode current collector.

FIG. 9C is a front view of the anode assembly of FIG. 9A.

FIG. 10A is a cross-sectional view of a tenth exemplary embodiment of an anode assembly for a battery cell.

FIG. 10B is a cross-sectional view of an exemplary embodiment of a multi-layer anode assembly comprising two anode assemblies of FIG. 10A, wherein the anode assemblies share a common anode current collector.

FIG. 10C is a front view of the anode assembly of FIG. 10A.

FIG. 11A is a cross-sectional view of a tenth exemplary embodiment of an anode assembly for a battery cell.

FIG. 11B is a cross-sectional view of an exemplary embodiment of a multi-layer anode assembly comprising two anode assemblies of FIG. 11A, wherein the anode assemblies share a common barrier film.

FIG. 11C is a front view of the anode assembly of FIG. 11A.

FIG. 12 is a flow chart of a method of forming an anode assembly according to one implementation of the invention.

FIG. 13A is a scanning electron microscope (SEM) image of a cross-section of an anode assembly according to Example 1, wherein an anode layer of the anode assembly shown.

FIG. 13B is a black and white modified energy dispersive X-ray analysis (EDX)-SEM image of a cross-section of the anode assembly of FIG. 13A, wherein a layer of nickel is shown disposed on the anode layer.

FIG. 13C is a black and white modified EDX-SEM image of cross-section of the anode assembly of FIG. 13A, wherein a layer of silver is shown disposed on the anode layer.

FIG. 13D is another SEM image of cross-section of the anode assembly of FIG. 13A, wherein the anode layer and a separator layer of the anode assembly are shown.

FIG. 13E is a black and white modified EDX-SEM image of a cross-section of the anode assembly of FIG. 13D, wherein a layer of nickel is shown.

FIG. 13F is a black and white modified EDX-SEM image of a cross-section of the anode assembly of FIG. 13D, wherein a layer of silver is shown.

FIG. 14A is another SEM image of a cross-section of the anode assembly according to Example 1, wherein the anode layer of the anode assembly is shown.

FIG. 14B is a black and white modified EDX-SEM image of a cross-section of the anode assembly of FIG. 14A, wherein a layer of nickel is shown.

FIG. 14C is a black and white modified EDX-SEM image of a cross-section of the anode assembly of FIG. 14A, wherein a layer of silver is shown.

FIG. 15A is a graph of voltage (V) vs. capacity (mAh/cm²) for a half-cell of Example 1.

FIG. 15B is a close-up view of the graph of FIG. 15A.

FIG. 15C is a plot of the electrochemical impedance spectroscopy (EIS) profile for the half-cell of Example 1 after 8 hours of cathodic current density at 20 μA/cm² in the frequency range of 2 MHz-1 Hz.

FIG. 16A is a graph of voltage (V) vs. capacity (mAh/cm²) for a battery cell of Example 2 during first-cycle charge and discharge at 180 μA/cm².

FIG. 16B is a close-up view of the graph of FIG. 16A.

FIG. 16C is a plot of the EIS profile for the battery cell of Example 2 after 12 hours first-cycle charge at 180 μA/cm² in the frequency range of 10 kHz-0.1 Hz.

FIG. 17A is a scanning electron microscope (SEM) image of a cross-section of an anode assembly according to Example 3, wherein an anode layer and separator layer of the anode assembly shown.

FIG. 17B is a black and white modified EDX-SEM image of a cross-section of the anode assembly of FIG. 17A, wherein a layer of indium is shown disposed on the anode layer.

FIG. 17C is a black and white modified EDX-SEM image of a cross-section of the anode assembly of FIG. 17A, wherein a layer of copper is shown disposed on the anode layer.

FIG. 18A is another SEM image of a cross-section of the anode assembly according to Example 1, wherein the anode layer of the anode assembly is shown.

FIG. 18B is a black and white modified EDX-SEM image of a cross-section of the anode assembly of FIG. 18A, wherein a layer of indium is shown.

FIG. 18C is a black and white modified EDX-SEM image of a cross-section of the anode assembly of FIG. 18A, wherein a layer of copper is shown.

FIG. 19 is a plot of voltage vs. time for a test cell of Example 4.

FIG. 20 is a plot of voltage vs. time for a test cell of Example 5.

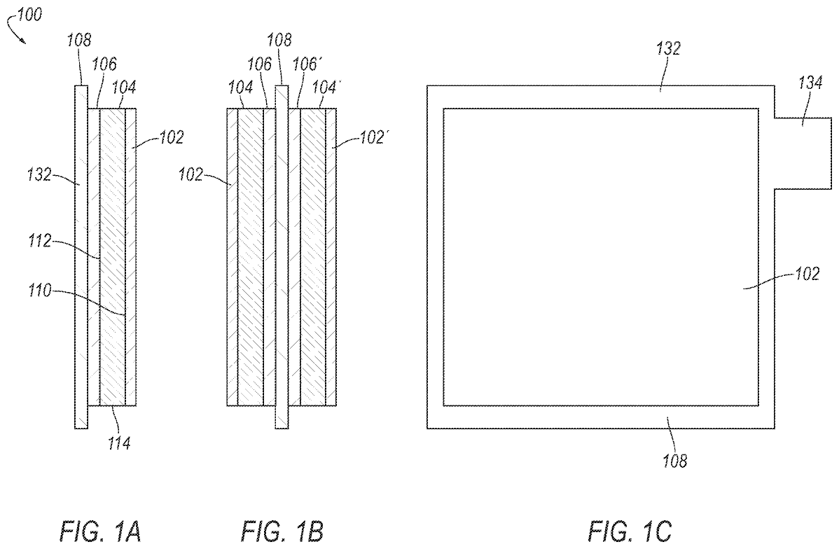

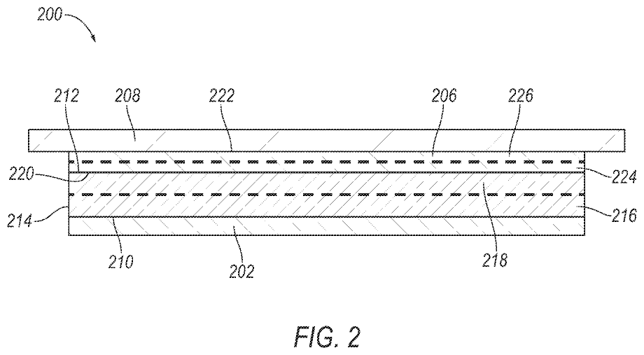

Like reference numerals in the various drawings indicate like elements. For example, the separator layer may be referred to as 102 in FIGS. 1A-1C and as 202 in FIG. 2.

### DETAILED DESCRIPTION

The present invention provides an anode assembly for a battery call, a battery cell comprising such an anode assembly, methods of forming such an anode assembly, and a multi-layer anode assembly.

As used herein, the following definitions shall apply unless otherwise indicated.

### I. Definitions

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

As used herein, when an element is referred to as being “on,” “engaged to,” “connected to,” “attached to,” or “coupled to” another element, it may be directly on, engaged, connected, attached, or coupled to the other element, or intervening elements may be present. In contrast, when an element is referred to as being “directly on,” “directly engaged to,” “directly connected to,” “directly attached to,” or “directly coupled to” another element, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, the term “battery cell” refers to a rechargeable secondary cell. In some embodiments, the battery cell may be a solid-state lithium-ion battery cell.

As used herein, the term “anode assembly” refers to an assembly comprising a separator layer, an anode layer, a deposited layer, and an anode current collector.

As used herein, the term “separator layer” refers to a layer disposed between an anode layer and a cathode layer in a battery cell and that permits cations (e.g., lithium cations) to flow between the anode and cathode layers. In some embodiments, the separator layer is substantially free of pores (e.g., having an apparent porosity of less than 50%, having an apparent porosity of less than 40%, having an apparent porosity of less than 30%, having an apparent porosity of less than 20%, having an apparent porosity of less than 15%, having an apparent porosity of less than 10%, having an apparent porosity of less than 5%, or having an apparent porosity of less than 1%). And, in some embodiments, the separator layer is free of pores.

As used herein, the term “anode layer” refers to a negative electrode layer from which electrons flow during the discharging phase of a battery cell. The anode layer is at least partially disposed on the separator layer and has a first surface facing the separator layer and a second surface facing away from the separator layer. The anode layer comprises a solid-state electrolyte (SSE) material having pores.

As used herein, the term “bi-layer” refers to the anode layer disposed on the separator layer.

As used herein, the term “deposited layer” refers to a layer at least partially disposed on the second surface of the anode layer. The deposited layer comprises at least one of a conductive material and a nucleation material. In some embodiments, the deposited layer facilitates electronic conductance. In some embodiments, the deposited layer electrochemically alloys and/or reacts with a metal material (e.g., lithium metal) at room temperature. And, in some embodiments, the deposited layer comprises at least one of an electrically conductive layer and a nucleation layer.

As used herein, the term “electrically conductive layer” refers to a layer that facilitates electronic conductance. The electrically conductive layer is at least partially disposed on the second surface of the anode layer. The electrically conductive layer comprises the conductive material. In some embodiments, the electrically conductive layer serves as a substrate for metal plating during operation (e.g., charging) of the battery cell.

As used herein, the term “conductive material” refers to a material that facilitates electronic conductance. The conductive material may be any material suitable for facilitating electronic conductance. In some embodiments, the conductive material comprises a metal, a metal oxide, a metal alloy, carbon black, carbon nanotubes, graphite, graphene, amorphous carbon, or any combination thereof. And, in some embodiments, the conductive material comprises copper, nickel, titanium, stainless steel, alloys thereof, or any combination thereof.

As used herein, the term “nucleation layer” refers to a layer that electrochemically alloys and/or reacts with a metal material (e.g., lithium metal) at room temperature. The nucleation layer is at least partially disposed on the second surface of the anode layer. The nucleation layer comprises the nucleation material.

As used herein, the term “nucleation material” refers to a material that electrochemically alloys and/or reacts with a metal material (e.g., lithium metal) at room temperature. The nucleation material may be any material suitable for alloying and/or reacting with the metal material. In some embodiments, the nucleation material of comprises silver, gold, aluminum, bismuth, antimony, indium, zinc, gallium, nickel oxide, titanium oxide, copper oxide, zinc oxide, graphene, graphite, carbon black, or any combination thereof.

As used herein, the term “anode current collector” refers to a current collector coupled to the deposited layer (e.g., at least one of the electrically conductive layer and the nucleation layer). The anode current collector is configured to be electrically coupled to the deposited layer during operation of the battery cell (e.g., charging and/or discharging of the battery cell). In some embodiments, the anode current collector comprises a metal foil. In other embodiments, the anode current collector comprises a tab configured to connect with an external circuit.

As used herein, the term “cathode assembly” refers to an assembly comprising a cathode layer and cathode current collector.

As used herein, the term “cathode layer” refers to a positive electrode layer into which electrons flow during the discharging phase of the battery cell.

As used herein, the term “cathode current collector” refers to a current collector coupled to the cathode layer. The cathode current collector is configured to be electrically coupled to the cathode layer during operation of the battery cell (e.g., charging and/or discharging of the battery cell). In some embodiments, the cathode current collector comprises a metal foil. In other embodiments, the cathode current collector comprises a tab configured to connect with an external circuit.

As used herein, the term “apparent porosity” refers to the open (or accessible) porosity (i.e., porosity that excludes volume(s) from sealed or closed pores, cells, or voids). Apparent porosity can be represented as a fraction or percentage of the volume of open pores, cells, or voids over the total volume.

### II. Anode Assembly

In one aspect, the present invention provides an anode assembly for a battery cell.

As shown in FIGS. 1A and 1C, the anode assembly 100 comprises a separator layer 102, an anode layer 104, a deposited layer 106, and an anode current collector 108.

### A. Separator Layer

The separator layer may be comprised of any suitable material that permits cations (e.g., lithium cations) to flow between anode and cathode layers during operation (e.g., charging and/or discharging) of a battery cell. In some embodiments, the separator layer comprises a solid-state electrolyte (SSE) material. For example, the SSE material of the separator layer may comprise a polymer, a sulfide, an oxide, a chalcogenide, or any combination thereof. For example, the SSE material may comprise a sulfide. In some embodiments, the SSE material comprises LSS, LTS, LXPS, LXPSO, LATS, lithium garnets, or any combination thereof, wherein X is Si, Ge, Sn, As, Al, or any combination thereof, wherein S is S, Si, or any combination thereof, and wherein T is Sn.

As used herein, “LSS” refers to lithium silicon sulfide, which can be described as Li₂S—SiS₂, Li—SiS₂, Li—S—Si, or a SSE material comprising Li, S, and Si. In some embodiments, LSS comprise LiₓSi_{y}S_{z}, wherein 0.33≤x≤0.5, 0.1≤y≤0.2, and 0.4≤z≤0.55. In some embodiments, LSS may comprise up to 10 atomic % oxygen. In other embodiments, LSS may comprise a SSE material comprising Li, Si, and S. In some embodiments, LSS comprises a mixture of Li₂S and SiS₂. In some embodiments, a molar ratio of Li₂S:SiS₂ is 90:10, 85:15, 80:20, 75:25, 70:30, 2:1, 65:35, 60:40, 55:45, or 50:50. In some embodiments, LSS may further comprise a doped compound such as LiₓPO_{y}, LiₓBO_{y}, Li₄SiO₄, Li₃MO₄, Li₃MO₃, PS, and/or lithium halides such as, but not limited to, LiI, LiCl, LiF, or LiBr, wherein 0<x≤5 and 0<y≤5.

As used herein, “LTS” refers to a lithium tin sulfide compound, which can be described as Li₂S—SnS₂, Li₂S—SnS, Li—S—Sn, or an SSE material comprising Li, S, and Sn. In some embodiments, LTS may comprise LiₓSn_{y}S_{z}, wherein 0.25≤x≤0.65, 0.05≤y≤0.2, and 0.25≤z≤0.65. In some embodiments, LTS may comprise a mixture of Li₂S and SnS₂ in a molar ratio (i.e., Li₂S:SnS₂) of 80:20, 75:25, 70:30, 2:1, or 1:1. In some embodiments, LTS may comprise up to 10 atomic % oxygen. In other embodiments, LTS may be doped with Bi, Sb, As, P, B, Al, Ge, Ga, In, or any combination thereof. As used herein, “LATS” refers to LTS, as used above, and further comprising Arsenic (As).

As used herein, “LXPS” refers to a material characterized by the formula LiₐMP_{b}S_{c}, wherein M is Si, Ge, Sn, Al, or any combination thereof, and wherein 2≤a≤8, 0.5≤b≤2.5, and 4≤c≤12. “LSPS” refers to an electrolyte material characterized by the formula LₐSiP_{b}S_{c}, where 2≤a≤8, 0.5≤b≤2.5, 4≤c≤12.

When M is Sn and Si (i.e., both Sn and Si are present), the LXPS material is referred to as “LSTPS”. As used herein, “LSTPSO” refers to LSTPS that is doped with, or has, O present. In some embodiments, “LSTPSO” is a LSTPS material with an oxygen content between 0.01 and 10 atomic %. As used herein, “LSPS” refers to an electrolyte material having Li, Si, P, and S chemical constituents. As used herein “LSTPS,” refers to an electrolyte material having Li, Si, P, Sn, and S chemical constituents. As used herein, “LSPSO,” refers to LSPS that is doped with, or has, O present. In some embodiments, “LSPSO” is an LSPS material with an oxygen content between 0.01 and 10 atomic %. As used herein, “LATP” refers to an electrolyte material having Li, As, Sn, and P chemical constituents. As used herein “LAGP” refers to an electrolyte material having Li, As, Ge, and P chemical constituents. As used herein, “LXPSO” refers to an electrolyte material comprising LiₐMP_{b}S_{c}O_{d}, wherein M is Si, Ge, Sn, Al, or any combination thereof, and wherein 2≤a≤8, 0.5≤b≤2.5, 4≤c≤12, and d≤3. LXPSO refers to LXPS, as defined above, and having oxygen doping at from 0.1 to about 10 atomic %. As used herein, “LPS” refers to an electrolyte material comprises Li₂S—P₂S₅. As used herein, “LPSO” refers to LPS, as defined herein, and further comprising oxygen doping at from 0.1 to about 10 atomic %.

In some embodiments, the SSE material of the separator layer comprises a polymer. For example, the polymer may comprise polyolefins, natural rubbers, synthetic rubbers, polybutadiene, polyisoprene, epoxidized natural rubber, polyisobutylene, polypropylene oxide, polyacrylates, polymethacrylates, polyesters, polyvinyl esters, polyurethanes, styrenic polymers, epoxy resins, epoxy polymers, poly(bisphenol A-co-epichlorohydrin), vinyl polymers, polyvinyl halides, polyvinyl alcohol, polyethyleneimine, poly(maleic anhydride), silicone polymers, siloxane polymers, polyacrylonitrile, polyacrylamide, polychloroprene, polyvinylidene fluoride, polyvinyl pyrrolidone, polyepichlorohydrin, blends thereof, or copolymers thereof. In some embodiments, the polymer is polyolefins. In some embodiments, the polymer is natural rubbers. In some embodiments, the polymer is synthetic rubbers. In some embodiments, the polymer is polybutadiene. In some embodiments, the polymer is polyisoprene. In some embodiments, the polymer is epoxidized natural rubber. In other embodiments, the polymer is polyisobutylene. In some embodiments, the polymer is polypropylene oxide. In some embodiments, the polymer is polyacrylates. In some embodiments, the polymer is polymethacrylates. In some embodiments, the polymer is polyesters. In other embodiments, the polymer is polyvinyl esters. In some embodiments, the polymer is polyurethanes. In some embodiments, the polymer is styrenic polymers. In some embodiments, the polymer is epoxy resins. In some embodiments, the polymer is epoxy polymers. In some embodiments, the polymer is poly(bisphenol A-co-epichlorohydrin). In some embodiments, the polymer is vinyl polymers. In some embodiments, the polymer is polyvinyl halides. In some embodiments, the polymer is polyvinyl alcohol. In some embodiments, the polymer is polyethyleneimine. In other embodiments, the polymer is poly(maleic anhydride). In some embodiments, the polymer is silicone polymers. In some embodiments, the polymer is siloxane polymers. In some embodiments, the polymer is polyacrylonitrile. In some embodiments, the polymer is polyacrylamide. In some embodiments, the polymer is polychloroprene. In some embodiments, the polymer is polyvinylidene fluoride. In some embodiments, the polymer is polyvinyl pyrrolidone. In some embodiments, the polymer is polyepichlorohydrin. In some embodiments, a molecular weight of the polymer is greater than about 50,000 g/mol.

In some embodiments, the polymer is preformed and selected from the group consisting of polypropylene, polyethylene, polybutadiene, polyisoprene, epoxidized natural rubber, poly(butadiene-co-acrylonitrile), polyethyleneimine, polydimethylsiloxane, and poly(ethylene-co-vinyl acetate). In other embodiments, a molecular weight of the polymer is greater than about 50,000 g/mol.

When the SSE material comprises a polymer, the SSE material may further comprise a metal salt (e.g., a lithium salt (e.g., LiPF₆)).

In some embodiments, the SSE material of the separator layer comprises a lithium perovskite material, Li₃N, Li-β-alumina, Lithium Super-ionic Conductors (LISICON), Li_{2.88}PO_{3.86}N_{0.14} (LiPON), Li₉AlSiO₈, Li₁₀GeP₂S₁₂, lithium garnet SSE materials, doped lithium garnet SSE materials, lithium garnet composite materials, or any combination thereof. In various embodiments, the lithium garnet SSE material is cation-doped Li₅La₃M¹₂O₂, where M¹ is Nb, Zr, Ta, or any combination thereof, cation-doped Li₆La₂BaTa₂O₁₂, cation-doped Li₇La₃Zr₂O₁₂, and cation-doped Li₆BaY₂M¹₂O₁₂, where cation dopants are barium, yttrium, zinc, or combinations thereof, and the like. In various other embodiments, the lithium garnet SSE material is Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, Li_{6.75}BaLa₂Ta_{1.75}Zn_{0.25}O₂, or any combination thereof.

In some embodiments, the SSE material of the separator layer and the SSE material of the anode layer are the same (e.g., the SSE material of the separator layer may be any SSE material described herein for the anode layer). In other embodiments, the SSE material of the separator layer and the SSE material of the separator layer are different.

In some embodiments, the separator layer is substantially free of pores (e.g., having an apparent porosity of less than 50%, having an apparent porosity of less than 40%, having an apparent porosity of less than 30%, having an apparent porosity of less than 20%, having an apparent porosity of less than 15%, having an apparent porosity of less than 10%, having an apparent porosity of less than 5%, or having an apparent porosity of less than 1%). And, in some embodiments, the separator layer is free of pores.

In some embodiments, the separator layer has a thickness of from about 1 μm to about 300 μm. In some embodiments, the separator layer has a thickness of from about 1 μm to about 200 μm. In other embodiments, the separator layer has a thickness of from about 1 μm to about 100 μm. In some embodiments, the separator layer has a thickness of from about 1 μm to about 50 μm. In some embodiments, the separator layer has a thickness of from about 1 μm to about 20 μm. And, in some embodiments, the separator layer has a thickness of from about 1 μm to about 10 μm.

### B. Anode Layer

With reference again to FIG. 1A, the anode layer is at least partially disposed on the separator layer. The anode layer has a first surface 110 and a second surface 112. The first surface faces the separator layer and the second surface faces away from the separator layer. The anode layer comprises a SSE material having pores. In some embodiments, the anode layer is disposed on an entire surface of the separator layer. In other embodiments, the anode layer is disposed only on a portion of a surface of the separator layer. The anode layer has an outer 114 surface extending from the first surface to the second surface.

In some embodiments, the anode layer has an apparent porosity of from about 20% to about 80%. In other embodiments, the anode layer has an apparent porosity of from about 35% to about 75%. In some embodiments, the anode layer has an apparent porosity of from about 45% to about 65%. In some embodiments, the anode layer has an apparent porosity of from about 50% to about 60%. In some embodiments, the anode layer has an apparent porosity of from about 60% to about 80%. In some embodiments, the anode layer has an apparent porosity of from about 20% to about 95%. And, in some embodiments, the anode layer has an apparent porosity of from about 50% to about 90%.

In some embodiments, the SSE material of the anode layer and the SSE material of the separator layer are the same. In other embodiments, the SSE material of the anode layer and the SSE material of the separator layer are different. In some embodiments the SSE material comprises a lithium conductor, a sodium conductor, or a magnesium conductor. In some embodiments the SSE material comprises a lithium conductor. In other embodiments, the SSE material comprises a sodium conductor. And, in some embodiments, the SSE material comprises a magnesium conductor.

In some embodiments, the SSE material of the anode layer may comprise a garnet material. Non-limiting examples of garnet materials include lithium garnet materials, doped lithium garnet materials, lithium garnet composite materials, and combinations thereof. Non-limiting examples of lithium garnet materials include Li₃-phase lithium garnet SSE materials (e.g., Li₃M¹Te₂O₁₂, where M¹ is a lanthanide such as Y, Pr, Nd, Sm, Eu, Gd, Tb, Dy, Ho, Er, Tm, Yb, Lu, Zr, Ta, or a combination thereof and Li₃₊ₓNd₃TC₂₋ₓO₁₂, where x is 0.05 to 1.5; Li₅-phase lithium garnet SSE materials (e.g., Li₅La₃M²₂O₁₂, where M² is Nb, Zr, Ta, Sb, or a combination thereof, cation-substituted Li₅La₃M²₂O₁₂ such as, for example, Li₆M¹La₃M²₂O₁₂, where M¹ is Mg, Ca, Sr, Ba, or combinations thereof, and Li₇La₃M²₂O₁₂, where M² is Zr, Sn, or a combination thereof); Li₆-phase lithium garnet SSE materials (e.g., Li₆M¹La₂M²₂O₁₂, where M¹ is Mg, Ca, Sr, Ba, or a combination thereof and M² is Nb, Ta, or a combination thereof); cation-doped Li₆La₂BaTa₂O₁₂; cation-doped Li₆BaY₂M²₂O₁₂, where M² is Nb, Ta, or a combination thereof and the cation dopants are barium, yttrium, zinc, or combinations thereof, an Li₇-phase lithium garnet SSE material (e.g., cubic Li₇La₃Zr₂O₁₂ and Li₇Y₃Zr₂O₁₂); cation-doped Li₇La₃Zr₂O₁₂; Li₅₊₂ₓLa₃, Ta₂₋ₓO₂, where x is 0.1 to 1, Li_{6.8}(La_{2.95},Ca_{0.5})(Zr_{1.75},Nb_{0.25})O₁₂ (LLCZN), Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂), lithium garnet composite materials (e.g., lithium garnet-conductive carbon matrix or composites with other materials). Other examples of lithium-ion-conducting SSE materials include cubic garnet-type materials such as 3 mol % YSZ-doped Li_{7.6}La₃Zr_{1.94}Y_{0.06}O₂ and 8 mol % YSZ-doped Li_{7.16}La₃Zr_{1.94}Y_{0.06}O₁₂. Additional examples of suitable lithium-garnet SSE materials include, but are not limited to, Li₅La₃Nb₂O₁₂, Li₅La₃Ta₂O₁₂, Li₇La₃Zr₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₇Y₃Zr₂O₁₂, Li_{6.75}BaLa₂Nb_{1.75}Zn_{0.25}O₁₂, or Li_{6.75}BaLa₂Ta_{1.75}Zn_{0.25}O₁₂. In some embodiments, the garnet material is, for example, Li₇₋ₓLa_{3-y}M¹_{y}Zr_{2-z}M²_{z}O₁₂, wherein x greater than 0 and less than 2, M¹ is chosen from Ba, Ca, Y, and combinations thereof, and M² is chosen from Nb, Ta, and combinations thereof. In some embodiments, the garnet material is Li_{6.75}La₃Zr_{1.75}Ta_{0.25}O₁₂ (LLZT), Li_{6.75}La_{2.75}Zr_{1.75}Ca_{0.25}Nb_{0.25}O₂ (LLZCN), Li₅La₃Nb₂O₁₂ (LLZNO), Li₇La₃Zr₂O₁₂ (LLZ), Li₅La₃Ta₂O₁₂, Li₆La₂SrNb₂O₁₂, Li₆La₂BaNb₂O₁₂, Li₆La₂SrTa₂O₁₂, Li₆La₂BaTa₂O₁₂, Li₇Y₃Zr₂O₁₂, Li_{6.4}Y₃Zr_{1.4}Ta_{0.6}O₁₂, Li_{6.5}La_{2.5}Ba_{0.5}TaZrO₁₂, Li₆BaY₂M¹₂O₁₂, Li_{6.75}BaLa₂Nb_{1.75}Zn_{0.25}O₁₂, Li_{6.75}BaLa₂Ta_{1.75}Zn_{0.25}O₁₂, or any combination thereof.

In some embodiments, the garnet material comprises a composition of Formula (I):

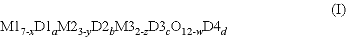

wherein
M1 is Li;
M2 is La;
M3 is Zr;
D1 is H, Be, B, Al, Fe, Zn, Ga, Ge, or any combination thereof;
D2 is Na, K, Ca, Rb, Sr, Y, Ag, Ba, Bi, Pr, Nd, Pm, Sm, Gd, Tb, Dy, Ho, Er, Tm, Zn, Ce, or any combination thereof;
D3 is Mg, Si, Sc, Ti, V, Cr, Mn, Co, Ni, Cu, Ge, As, Se, Nb, Mo, Tc, Ru, Rh, Pd, Cd, In, Sn, Sb, Hf, Ta, W, Ir, Pt, Au, Hg, Tl, Pb, Ce, Eu, Te, Y, Sr, Ca, Ba, Gd, Ge, or any combination thereof; and
D4 is F, Cl, Br, I, S, Se, Te, N, P, or any combination thereof; provided that

$$0 \leq w \leq 2 ;$$

$$- 0.5 < x \leq 3 ;$$

$$0 \leq y \leq 3 ;$$

$$0 \leq z \leq 2 ;$$

$$0 \leq a \leq 2 ;$$

$$0 \leq b \leq 3 ;$$

$$0 \leq c \leq 2 ; and$$

$$0 \leq d \leq 2 ;$$

wherein at least one of a, b, c, and d is >0.

In some embodiments, the pores of the anode layer are substantially free of a metal material (e.g., the pores comprise less than 1%, less than 0.5%, less than 0.25%, less than 0.1%, less than 0.01%, or less than 0.001% of a metal material by volume of the pores). In some embodiments, the pores of the anode layer are free of a metal material. In the context of this disclosure, when the pores of the anode layer are referred to as “substantially free of”, or “free of”, the metal material, it will be appreciated that the pores of the anode layer are substantially free, or free, of the metal material prior to operation of the battery cell, i.e., immediately after fabrication of the battery cell and prior to operation of the battery cell (e.g., charging/discharging of the battery cell).

In some embodiments, the metal material comprises a lithium material, a sodium material, a magnesium material, or any combination thereof. When the metal material comprises the lithium material, the lithium material comprises lithium metal. In other embodiments, the metal material comprises lithium metal, sodium metal, magnesium metal, or any combination thereof.

In some embodiments, the anode layer defines a first porous region 216 and a second porous region 218, as shown in FIG. 2. The first porous region is defined between the first and second surfaces 210, 212 of the anode layer. The second porous region is defined between the first porous region and the second surface of the anode layer.

In some embodiments, the pores of the first porous region are substantially free of a metal material (e.g., prior to operation of the battery cell). The metal material may be any metal material described herein (e.g., lithium metal).

In some embodiments, at least a portion of the pores of the second porous region comprise a conductive material, a nucleation material, or any combination thereof. In other embodiments, at least a portion of the pores of the second porous region comprise a conductive material. In some embodiments, at least a portion of the pores of the second porous region comprise a nucleation material. And, in some embodiments, at least a portion of the pores of the second porous region comprise a conductive material and a nucleation material.

The conductive material may be any conductive material described herein. For example, the conductive material may comprise a metal, a metal oxide, a metal alloy, carbon black, carbon nanotubes, graphite, graphene, amorphous carbon, or any combination thereof. In some embodiments, the conductive materials of the second porous region and the deposited layer are the same. In other embodiments, the conductive materials of the second porous region and the deposited layer are different.

The nucleation material may be any nucleation material described herein. For example, the nucleation material may comprise silver, gold, aluminum, bismuth, antimony, indium, zinc, gallium, nickel oxide, titanium oxide, copper oxide, zinc oxide, or any combination thereof. In some embodiments, the nucleation materials of the second porous region and the deposited layer are the same. In other embodiments, the nucleation materials of the second porous region and the deposited layer are different.

In some embodiments, the anode layer has a thickness of from about 1 μm to about 500 μm. In some embodiments, the anode layer has a thickness of from about 1 μm to about 200 μm. In other embodiments, the anode layer has a thickness of from about 1 μm to about 100 μm. In some embodiments, the anode layer has a thickness of from about 1 μm to about 50 μm. And, in some embodiments, the anode layer has a thickness of from about 1 μm to about 20 μm.

### C. Deposited Layer

The deposited layer is at least partially disposed on the second surface of the anode layer. The deposited layer comprises at least one of a conductive material and a nucleation material. In some embodiments, the deposited layer is disposed on the entire second surface of the anode layer. In some embodiments, the deposited layer is disposed on substantially all (e.g., at least 60%, at least 70%, at least 80%, at least 90%, or at least 95%) of the second surface of the anode layer. In other embodiments, the deposited layer is disposed only on a portion of the anode layer.

In some embodiments, the deposited layer facilitates electronic conductance. In some embodiments, the deposited layer electrochemically alloys and/or reacts with a metal material (e.g., lithium metal) at room temperature. And, in some embodiments, the electrically conductive layer serves as a substrate for metal plating (e.g., lithium plating) during operation (e.g., charging) of the battery cell.

In some embodiments, the deposited layer comprises the conductive material. In other embodiments, the deposited layer comprises the nucleation material. And, in some embodiments, the deposited layer comprises the conductive material and the nucleation material.

The conductive material facilitates electronic conductance. In some embodiments, the conductive material comprises a metal, a metal oxide, a metal alloy, carbon black, carbon nanotubes, graphite, graphene, amorphous carbon, or any combination thereof. Suitable metals for the conductive material include, by way of non-limiting example, copper, nickel, titanium, iron, and combinations thereof. Suitable metal oxides for the conductive material include, by way of non-limiting example, oxides of copper, oxides of nickel, oxides of titanium, oxides of iron, and combinations thereof. And, suitable alloys for the conductive material include, by way or non-limiting example, copper alloys, nickel alloys, titanium alloys, iron alloys, and combinations thereof.

In some embodiments, the conductive material comprises carbon black, carbon nanotubes, graphite, graphene, amorphous carbon, or any combination thereof. In some embodiments, the conductive material comprises carbon black. In other embodiments, the conductive material comprises carbon nanotubes. In some embodiments, the conductive material comprises graphite. In some embodiments, the conductive material comprises graphene. And, in some embodiments, the conductive material comprises amorphous carbon.

In some embodiments, the conductive material comprises a metal, a metal alloy, or any combination thereof. In some embodiments, the conductive material comprises copper, nickel, titanium, stainless steel, alloys thereof, or any combination thereof. In some embodiments, the conductive material comprises copper. In some embodiments, the conductive material comprises nickel. In other embodiments, the conductive material comprises titanium. In some embodiments, the conductive material comprises steel. In some embodiments, the conductive material comprises a copper alloy. In some embodiments, the conductive material comprises a nickel alloy. In other embodiments, the conductive material comprises a titanium alloy. And, in some embodiments, the conductive material comprises a steel alloy.

In some embodiments, the conductive material is substantially free of, or free of, a metal or a metal alloy that reacts with lithium metal, sodium metal, or magnesium metal at room temperature or forms an alloy with lithium metal, sodium metal, or magnesium metal at room temperature (e.g., the deposited layer comprises less than 5%, less than 2.5%, less than 1%, less than 0.5%, less than 0.1%, less than 0.01%, or 0% of such a metal or metal alloy by weight of the deposited layer). In other embodiments, the conductive material is substantially free of a metal or a metal alloy that reacts with lithium metal at room temperature or forms an alloy with lithium metal at room temperature. In some embodiments, the conductive material is free of a metal or a metal alloy that reacts with lithium metal at room temperature or forms an alloy with lithium metal at room temperature. In such embodiments, the deposited layer may serve as a substrate for metal plating (e.g., lithium plating) during operation (e.g., charging) of the battery cell.

The nucleation material electrochemically alloys and/or reacts with a metal material (e.g., lithium metal) at room temperature. The nucleation material may be any suitable material for electrochemically alloying with and/or reacting with a metal material (e.g., lithium metal) at room temperature.

In some embodiments, the nucleation material and the conductive material are the same. In other embodiments, the nucleation material and the conductive material are different.

In some embodiments, the nucleation material comprises a metal, a metalloid, oxides thereof, or any combination thereof. In some embodiments, the nucleation material comprises silver, gold, aluminum, bismuth, antimony, indium, zinc, gallium, nickel oxide, titanium oxide, copper oxide, zinc oxide, graphene, graphite, carbon black, or any combination thereof. In some embodiments, the nucleation material comprises gold. In some embodiments, the nucleation material comprises silver. In other embodiments, the nucleation material comprises aluminum. In some embodiments, the nucleation material comprises bismuth. In some embodiments, the nucleation material comprises antimony. In some embodiments, the nucleation material comprises indium. In some embodiments, the nucleation material comprises zinc. In other embodiments, the nucleation material comprises gallium. In some embodiments, the nucleation material comprises nickel oxide. In some embodiments, the nucleation material comprises titanium oxide. In some embodiments, the nucleation material comprises copper oxide. In some embodiments, the nucleation material comprises graphene. And, in some embodiments, the nucleation material comprises zinc oxide.

In some embodiments, the deposited layer consists essentially of the conductive material. In other embodiments, the deposited layer consists essentially of the nucleation material. And, in some embodiments, the deposited layer consists essentially of the conductive material and the nucleation material.

In some embodiments, the deposited layer consists of the conductive material. In other embodiments, the deposited layer consists of the nucleation material. And, in some embodiments, the deposited layer consists of the conductive material and the nucleation material.

The deposited layer has a first surface 220 facing the anode layer and a second surface 222 facing away from the anode layer, as shown in FIG. 2. In some embodiments, the deposited layer defines a first deposited region 224 and a second deposited region 226. The first deposited region is defined between the first and second surfaces of the deposited layer. The second deposited region is defined between the first porous region and the second surface of the deposited layer. In some embodiments, a volume of the first deposited region is the same as a volume of the second deposited region.

In some embodiments, an amount (e.g., w/w %) of the nucleation material present in the first deposited region is greater than an amount (e.g., w/w %) of the nucleation material present in the second deposited region. In other embodiments, an amount of the nucleation material present in the first deposited region is less than an amount of the nucleation material present in the second deposited region.

In some embodiments, an amount (e.g., w/w %) of the conductive material present in the first deposited region is greater than an amount (e.g., w/w %) of the conductive material present in the second deposited region. In other embodiments, an amount of the conductive material present in the first deposited region is less than an amount of conductive material present in the second deposited region.

In some embodiments, an amount (e.g., w/w %) of the nucleation material present in the first deposited region is greater than an amount (e.g., w/w %) of the conductive material present in the first deposited region. In other embodiments, an amount of the nucleation material present in the first deposited region is less than an amount of the conductive material present in the first deposited region.

In some embodiments, an amount (e.g., w/w %) of the nucleation material present in the second deposited region is greater than an amount (e.g., w/w %) of the conductive material present in the second deposited region. In other embodiments, an amount of the nucleation material present in the second deposited region is less than an amount of the conductive material present in the second deposited region.

In some embodiments, an amount (e.g., w/w %) of the nucleation material present in the first deposited region is the same as an amount (e.g., w/w %) of the nucleation material present in the second deposited region. In other embodiments, an amount of the conductive material present in the first deposited region is the same as an amount of the conductive material present in the second deposited region.

In some embodiments, an amount (e.g., w/w %) of the nucleation material present in the first deposited region is the same as an amount (e.g., w/w %) of the conductive material present in the first deposited region. In other embodiments, an amount of the nucleation material present in the second deposited region is the same as an amount of the conductive material present in the second deposited region.

In some embodiments, the deposited layer has a thickness of from about 1 nm to about 20 μm. In other embodiments, the deposited layer has a thickness of from about 1 nm to about 5 μm. In some embodiments, the deposited layer has a thickness of from about 1 nm to about 1 μm. And, in some embodiments, the deposited layer has a thickness of from about 1 nm to about 100 nm.

In some embodiments, the deposited layer is substantially impervious to liquid. In the context of this disclosure, the term “substantially impervious” means that the corresponding component (e.g., deposited layer) is resistant to liquid penetration. In other words, liquid cannot pass freely through the corresponding component (e.g., deposited layer).

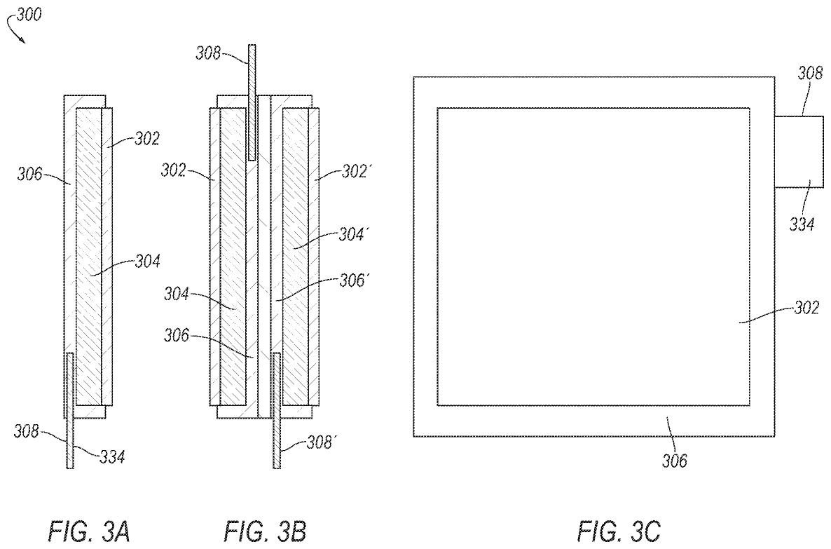

In some embodiments, the deposited layer is substantially impervious to liquid and pervious to gas. In such embodiments, the deposited layer may function in a similar manner to a seal, particularly in embodiments wherein the deposited layer is disposed entirely on the second surface of the anode layer and entirely on the outer surface of the anode layer, as shown in FIG. 3A. When the deposited layer is substantially impervious to liquid and pervious to gas, the deposited layer may restrict flow of a catholyte into the anode layer while permitting venting of gases from the anode layer.

In some embodiments, the deposited layer comprises at least one of an electrically conductive layer and a nucleation layer. In such embodiments, the anode current collector is coupled to the at least one of the electrically conductive layer and the nucleation layer.

In some embodiments, the deposited layer comprises the electrically conductive layer. In other embodiments, the deposited layer comprises the nucleation layer.

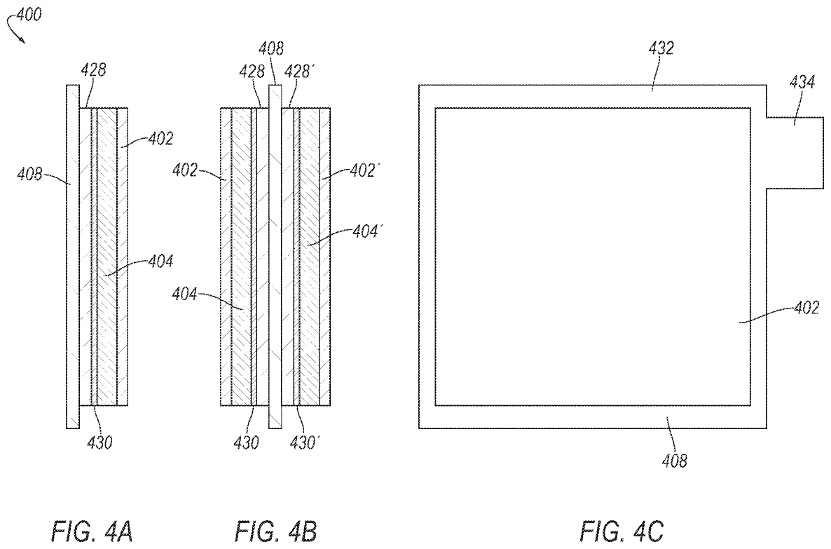

In some embodiments, as shown in FIG. 4A, the deposited layer comprises the electrically conductive layer 428 and the nucleation layer 430. In some embodiments, and as illustrated, the nucleation layer is disposed between the anode layer and the electrically conductive layer. In other embodiments, the electrically conductive layer is disposed between the anode layer and the nucleation layer.

### 1. Electrically Conductive Layer

The electrically conductive layer is at least partially disposed on the second surface of the anode layer and comprises the conductive material. When present, the electrically conductive layer facilitates electronic conductance. In some embodiments, the electrically conductive layer serves as a substrate for metal plating (e.g., lithium plating) during operation (e.g., charging) of the battery cell.

The conductive material of the electrically conductive layer may be any conductive material described herein. In some embodiments, the conductive material comprises a metal, a metal oxide, a metal alloy, carbon black, carbon nanotubes, graphite, graphene, amorphous carbon, or any combination thereof. Suitable metals for the conductive material include, by way of non-limiting example, copper, nickel, titanium, iron, and combinations thereof. Suitable metal oxides for the conductive material include, byway of non-limiting example, oxides of copper, oxides of nickel, oxides of titanium, oxides of iron, and combinations thereof. And, suitable alloys for the conductive material include, by way or non-limiting example, copper alloys, nickel alloys, titanium alloys, iron alloys, and combinations thereof.

In some embodiments, the conductive material comprises carbon black, carbon nanotubes, graphite, graphene, amorphous carbon, or any combination thereof. In some embodiments, the conductive material comprises carbon black. In other embodiments, the conductive material comprises carbon nanotubes. In some embodiments, the conductive material comprises graphite. In some embodiments, the conductive material comprises graphene. And, in some embodiments, the conductive material comprises amorphous carbon.

In some embodiments, the conductive material comprises a metal, a metal alloy, or any combination thereof. In some embodiments, the conductive material comprises copper, nickel, titanium, stainless steel, alloys thereof, or any combination thereof. In some embodiments, the conductive material comprises copper. In some embodiments, the conductive material comprises nickel. In other embodiments, the conductive material comprises titanium. In some embodiments, the conductive material comprises steel. In some embodiments, the conductive material comprises a copper alloy. In some embodiments, the conductive material comprises a nickel alloy. In other embodiments, the conductive material comprises a titanium alloy. In some embodiments, the conductive material comprises graphene. In some embodiments, the conductive material comprises graphite. In some embodiments, the conductive material comprises a carbon black. And, in some embodiments, the conductive material comprises a steel alloy.

In some embodiments, the electrically conductive layer is substantially free of a metal or a metal alloy that reacts with lithium metal at room temperature or forms an alloy with lithium metal at room temperature.

In some embodiments, the electrically conductive layer consists essentially of the conductive material. In other embodiments, the electrically conductive layer consists essentially of the conductive material.

In some embodiments, the electrically conductive layer has a thickness of from about 1 nm to about 15 μm. In other embodiments, the electrically conductive layer has a thickness of from about 1 nm to about 1 μm. In some embodiments, the electrically conductive layer has a thickness of from about 1 nm to about 500 nm. And, in some embodiments, the electrically conductive layer has a thickness of from about 1 nm to about 100 nm.

In some embodiments, the electrically conductive layer is substantially impervious to liquid. In some embodiments, the electrically conductive layer is substantially impervious to liquid and pervious to gas. In such embodiments, the electrically conductive layer may function in a similar manner to a seal, particularly in embodiments wherein the electrically conductive layer is disposed entirely on the second surface of the anode layer and entirely on the outer surface of the anode layer. When the electrically conductive layer is substantially impervious to liquid and pervious to gas, the electrically conductive layer may restrict flow of a catholyte into the anode layer while permitting venting of gases from the anode layer.

In some embodiments, the electrically conductive layer is further defined as a first electrically conductive layer, and the anode assembly further comprises a second electrically conductive layer. The second electrically conductive layer is at least partially disposed on the first electrically conductive layer. The second electrically conductive layer comprises a conductive material. The conductive material of the second electrically conductive layer may be any conductive material described herein. In some embodiments, the conductive material of the first and second electrically conductive layers is the same. In other embodiments, the conductive material of the first and second electrically conductive layers is different.

### 2. Nucleation Layer

The nucleation layer is at least partially disposed on the second surface of the anode layer and comprises the nucleation material. When present, the nucleation layer electrochemically alloys and/or reacts with a metal material (e.g., lithium metal) at room temperature.

The nucleation material of the nucleation layer may be any nucleation material described herein. In some embodiments, the nucleation material comprises a metal, a metalloid, oxides thereof, or any combination thereof. In some embodiments, the nucleation material comprises silver, gold, aluminum, bismuth, antimony, indium, zinc, gallium, nickel oxide, titanium oxide, copper oxide, zinc oxide, graphene, graphite, carbon black, or any combination thereof. In some embodiments, the nucleation material comprises gold. In some embodiments, the nucleation material comprises silver. In other embodiments, the nucleation material comprises aluminum. In some embodiments, the nucleation material comprises bismuth. In some embodiments, the nucleation material comprises antimony. In some embodiments, the nucleation material comprises indium. In some embodiments, the nucleation material comprises zinc. In other embodiments, the nucleation material comprises gallium. In some embodiments, the nucleation material comprises nickel oxide. In some embodiments, the nucleation material comprises titanium oxide. In some embodiments, the nucleation material comprises copper oxide. In some embodiments, the nucleation material comprises graphene. And, in some embodiments, the nucleation material comprises zinc oxide.

In some embodiments, the nucleation layer consists essentially of the nucleation material. In other embodiments, the nucleation layer consists of the nucleation material.

In some embodiments, the nucleation layer has a thickness of from about 1 nm to about 1 μm. In other embodiments, the nucleation layer has a thickness of from about 1 nm to about 500 nm. In some embodiments, the nucleation layer has a thickness of from about 1 nm to about 100 nm. And, in some embodiments, the nucleation layer has a thickness of from about 1 nm to about 50 nm.

In some embodiments, the nucleation layer is substantially impervious to liquid. In some embodiments, the nucleation layer is substantially impervious to liquid and pervious to gas. In such embodiments, the nucleation layer may function in a similar manner to a seal, particularly in embodiments wherein the nucleation layer is disposed entirely on the second surface of the anode layer and entirely on the outer surface of the anode layer. When the nucleation layer is substantially impervious to liquid and pervious to gas, the nucleation layer may restrict flow of a catholyte into the anode layer while permitting venting of gases from the anode layer.

In some embodiments, the nucleation layer is further defined as a first nucleation layer, and the anode assembly further comprises a second nucleation layer. The second nucleation layer is at least partially disposed on the first nucleation layer. The second nucleation layer comprises a nucleation material. The nucleation material of the second nucleation layer may be any nucleation material described herein. In some embodiments, the nucleation material of the first and second nucleation layers is the same. In other embodiments, the nucleation material of the first and second nucleation layers is different.

### D. Anode Current Collector

The anode current collector is coupled to the deposited layer. In some embodiments, when the deposited layer comprises at least one of the electrically conductive and nucleation layers, the anode current collector is coupled to the at least one of the electrically conductive layer and the nucleation layer. For example, the anode current collector may be coupled to the electrically conductive layer. In other embodiments, the anode current collector is coupled to the nucleation layer. And, in some embodiments, the anode current collector is coupled to the electrically conductive layer and the nucleation layer.

With reference to FIGS. 1A and 1C, in some embodiments, the anode current collector comprises a metal foil 132. In such embodiments, the metal foil is at least partially disposed on a surface of the deposited layer. For example, the metal foil may be disposed on an entire surface of the deposited layer, as shown in FIGS. 1A and 1C. When the deposited layer comprises the at least one of the electrically conductive layer and the nucleation layer, the metal foil may be disposed on an entire surface of electrically conductive layer and/or the nucleation layer. In other embodiments, the metal foil is only partially disposed on the deposited layer. And, in some embodiments, the metal foil is only partially disposed on the electrically conductive layer and/or nucleation layer.

In some embodiments, the metal foil has a tab 134 configured to connect with an external circuit, as shown in FIG. 1C. In the illustrated embodiment, the tab is integral with the metal foil. In other embodiments, the tab is coupled (e.g., welded) to the metal foil.

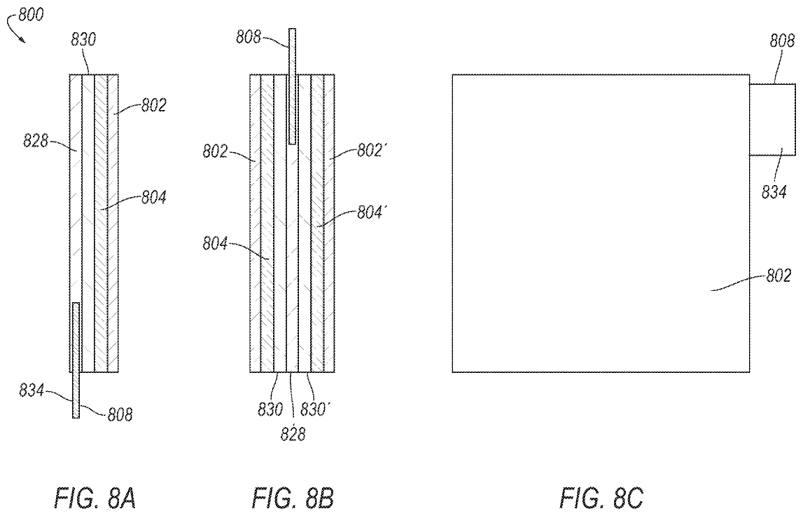

As shown in FIGS. 3A, 3C, 5A, 5C, 6A, 6C, 7A, 7C, 8A, and 8C, the anode current collector may comprise a tab 334, 534, 634, 734, 834 configured to connect with an external circuit. The tab may be partially disposed in the deposited layer, as shown in FIGS. 3A, 5A, 6A, 7A, and 7C. In other embodiments, the tab is partially disposed in the electrically conductive layer, as shown in FIG. 8A. In some embodiments, the tab is partially disposed in the nucleation layer. And, in some embodiments, the anode current collector is at least partially disposed on a surface of the deposited layer, the electrically conductive layer, and/or the nucleation layer.

The anode current collector may be comprised of any suitable material. In some embodiments, the anode current collector (e.g., the metal foil and/or the tab) comprises copper, nickel, titanium, stainless steel, alloys thereof, or any combination thereof. In some embodiments, the anode current collector comprises copper. In other embodiments, the anode current collector comprises a copper alloy. In some embodiments, the anode current collector comprises nickel. In other embodiments, the anode current collector comprises a nickel alloy. In some embodiments, the anode current collector comprises titanium. In some embodiments, the anode current collector comprises a titanium alloy. In some embodiments, the anode current collector comprises stainless steel. And, in some embodiments, the anode current collector comprises a stainless steel alloy.

In some embodiments, the anode current collector comprises a film. For example, the film may comprise a polymer material and a conductive material. The conductive material may be any conductive material described herein. In some embodiments, the conductive material comprises copper, nickel, titanium, stainless steel, alloys thereof, or any combination thereof. In some embodiments, the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof. When the anode current collector comprises a film, the anode current collector may be substantially impervious to liquid.

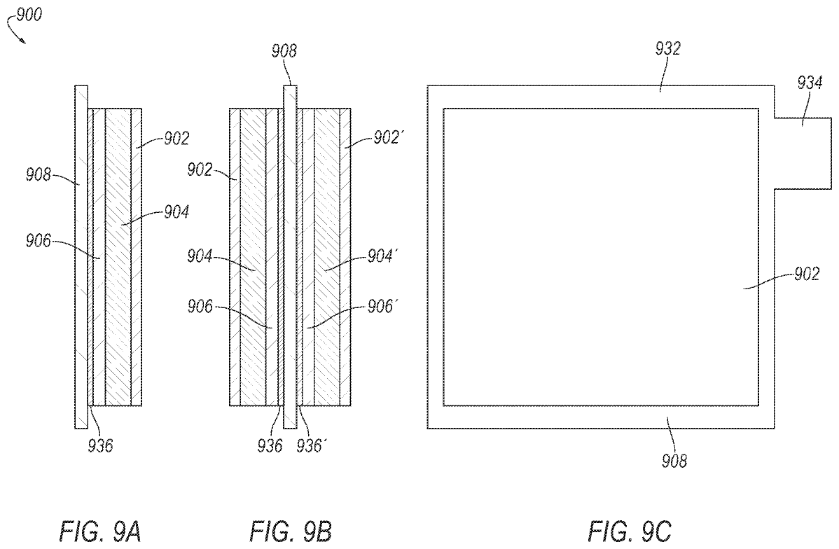

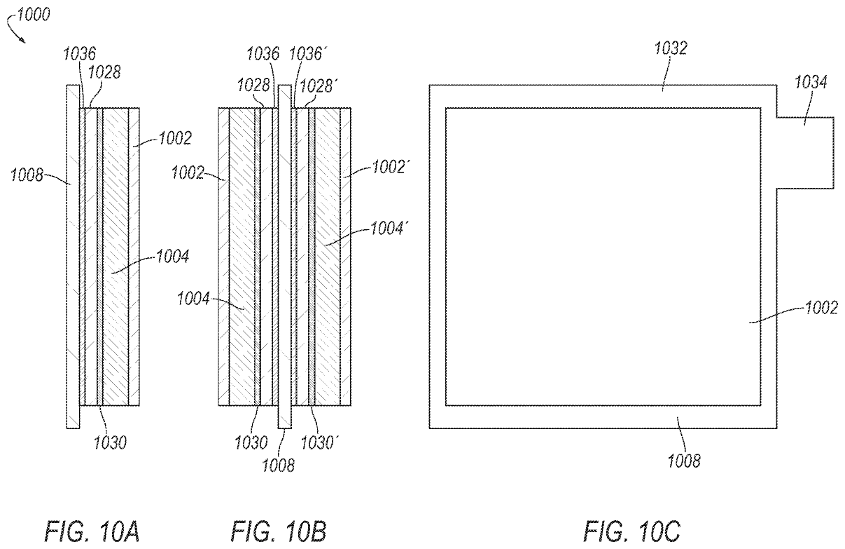

With reference to FIG. 9A, electrically conductive tape 936 may couple the anode current collector to the deposited layer. When the deposited layer comprises the at least one of the electrically conductive layer and the nucleation layer, electrically conductive tape may couple the anode current collector to the at least one of the electrically conductive layer and the nucleation layer. For example, electrically conductive tape 1036 may couple the anode current collector to the electrically conductive layer as shown in FIG. 10A. In other embodiments, electrically conductive tape couples the anode current collector to the nucleation layer. And, in some embodiments, electrically conductive tape couples the anode current collector to the electrically conductive layer and the nucleation layer. During operation of the battery cell (e.g., charging and/or discharging of the battery cell), the electrically conductive tape may electrically couple the anode current collector to the deposited layer, the electrically conductive layer, and/or the nucleation layer.

In some embodiments, a brazing material couples the anode current collector to the deposited layer. When the deposited layer comprises the at least one of the electrically conductive layer and the nucleation layer, the brazing material may couple the anode current collector to the at least one of the electrically conductive layer and the nucleation layer. For example, the brazing material may couple the anode current collector to the electrically conductive layer. In other embodiments, the brazing material couples the anode current collector to the nucleation layer. In some embodiments, the brazing material couples the anode current collector to the electrically conductive layer and the nucleation layer.

The brazing material may be any suitable material for electrically coupling the anode current collector to the deposited layer, the electrically conductive layer, and/or the nucleation layer. For the example, the brazing material may comprise silver, gold, aluminum, bismuth, antimony, zinc, indium, copper, phosphorus, nickel, titanium, tungsten, chromium, silicon, vanadium, tantalum, zirconium, alloys thereof, or any combination thereof. In some embodiments, the brazing material comprises silver. In some embodiments, the brazing material comprises a silver alloy. In some embodiments, the brazing material comprises gold. In other embodiments, the brazing material comprises a gold alloy. In some embodiments, the brazing material comprises aluminum. In some embodiments, the brazing material comprises an aluminum alloy. In some embodiments, the brazing material comprises bismuth. In other embodiments, the brazing material comprises a bismuth alloy. In some embodiments, the brazing material comprises antimony. In some embodiments, the brazing material comprises an antimony alloy. In some embodiments, the brazing material comprises zinc. In other embodiments, the brazing material comprises a zinc alloy. In some embodiments, the brazing material comprises indium. In some embodiments, the brazing material comprises an indium alloy. In some embodiments, the brazing material comprises copper. In some embodiments, the brazing material comprises a copper alloy. In some embodiments, the brazing material comprises phosphorus. In other embodiments, the brazing material comprises a phosphorus alloy. In some embodiments, the brazing material comprises nickel. In some embodiments, the brazing material comprises a nickel alloy. In some embodiments, the brazing material comprises titanium. In other embodiments, the brazing material comprises a titanium alloy. In some embodiments, the brazing material comprises tungsten. In some embodiments, the brazing material comprises a tungsten alloy. In some embodiments, the brazing material comprises chromium. In some embodiments, the brazing material comprises a chromium alloy. In some embodiments, the brazing material comprises silicon. In other embodiments, the brazing material comprises a silicon alloy. In some embodiments, the brazing material comprises vanadium. In some embodiments, the brazing material comprises a vanadium alloy. In some embodiments, the brazing material comprises tantalum. In other embodiments, the brazing material comprises a tantalum alloy. In some embodiments, the brazing material comprises zirconium. And, in some embodiments, the brazing material comprises a zirconium alloy.

In some embodiments, the deposited layer, the electrically conductive layer, and/or the nucleation layer serves as a brazing material for the anode current collector.

### E. Seal Layer

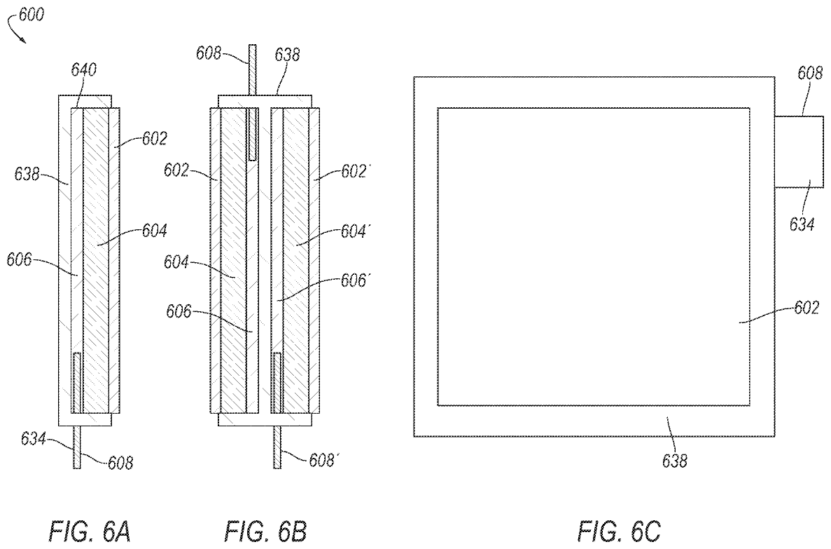

As shown in FIGS. 6A and 6C, in some embodiments, the anode assembly further comprises a seal layer 638 that is substantially impervious to liquid. In some embodiments, the seal layer is substantially impervious to liquid and pervious to gas.

In some embodiments, the seal layer ensures that metal plating (e.g., lithium plating) is confined to the pores of the anode layer during charging. In other words, the seal layer restricts metal (e.g., lithium metal) from plating in locations other than the pores of the anode layer during charging. The seal layer may also restrict flow of a catholyte into the anode layer during operation of the battery cell. And, in some embodiments, the seal layer couples or bonds the anode current collector to the deposited layer (e.g., an electrically conductive material, a nucleation material, or both).

In some embodiments, the seal layer is at least partially disposed on a surface of the anode current collector that faces away from the deposited layer. For example, the seal layer may be disposed on an entire surface of the anode current collector that faces away from the deposited layer. In other embodiments, the seal layer is only partially disposed on the surface of the anode current collector that faces away from the deposited layer.

In other embodiments, the seal layer is at least partially disposed on a surface of the deposited layer that faces away from the anode layer, as shown in FIG. 6A. In the illustrated embodiment, the seal layer is disposed on an entire surface of the deposited layer that faces away from the anode layer. With continued reference to FIG. 6A, the seal layer may be at least partially disposed on an outer surface 640 of the deposited layer. In the illustrated embodiment, the seal layer is disposed on the entire outer surface of the deposited layer. In other embodiments, the seal layer is only partially disposed on the outer surface of the deposited layer.

In some embodiments, when the deposited layer comprises at least one of the electrically conductive layer and the nucleation layer, the seal layer is disposed at least partially on the at least one of the electrically conductive layer and the nucleation layer. For example, the seal layer may be disposed at least partially on the electrically conductive layer. In other embodiments, the seal layer is at least partially disposed on the nucleation layer. And, in some embodiments, the seal layer is at least partially disposed on the electrically conductive layer and the nucleation layer.

When the seal layer is at least partially disposed on the outer surface of the deposited layer, electrically conductive layer, and/or nucleation layer, and the anode current collector comprises the tab, the tab may be at least partially disposed in the seal layer, as shown in FIG. 6A.

With continued reference to FIG. 6A, the seal layer may be at least partially disposed on the outer surface 614 of the anode layer. In some embodiments, the seal layer is disposed on the entire outer surface of the anode layer. In other embodiments, the seal layer is only partially disposed on the outer surface of the anode layer.

The seal layer may be comprised of any suitable material that restricts metal (e.g., lithium metal) from plating in locations other than the pores of the anode layer during charging. For example, the seal layer may comprise a polymer. In some embodiments, the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof. In some embodiments, the polymer comprises polypropylene. In some embodiments, the polymer comprises polyethylene. In other embodiments, the polymer comprises polymethylpentene. In some embodiments, the polymer comprises polybutene-1. In some embodiments, the polymer comprises ethylene-octene copolymers. In some embodiments, the polymer comprises propylene-butane copolymers. In some embodiments, the polymer comprises polyisobutylene. In some embodiments, the polymer comprises poly(α-olefin). In some embodiments, the polymer comprises ethylene propylene rubber. In other embodiments, the polymer comprises ethylene propylene diene monomer rubber. In some embodiments, the polymer comprises ethylene-vinyl acetate. In some embodiments, the polymer comprises ethylene-acrylate copolymers. In other embodiments, the polymer comprises polyamides. In some embodiments, the polymer comprises polyesters. In some embodiments, the polymer comprises polyurethanes. In some embodiments, the polymer comprises styrene block copolymers. In some embodiments, the polymer comprises polycaprolactone. In other embodiments, the polymer comprises polyimide. In some embodiments, the polymer comprises polyvinyl chloride. In some embodiments, the polymer comprises polycarbonates. In some embodiments, the polymer comprises polyacrylates. In some embodiments, the polymer comprises polymethacrylates. In some embodiments, the polymer comprises fluoropolymers. In some embodiments, the polymer comprises epoxy resins. In other embodiments, the polymer comprises epoxy polymers. And, in some embodiments, the polymer comprises silicone rubber.

In some embodiments, the seal layer comprises a conductive material. The conductive material of the seal layer may be any conductive material described herein.

In some embodiments, the seal layer has a thickness of from about 1 μm to about 50 μm. In other embodiments, the seal layer has a thickness of from about 1 μm to about 20 μm. In some embodiments, the seal layer has a thickness of from about 1 μm to about 10 μm. And, in some embodiments, seal layer has a thickness of from about 1 μm to about 5 μm.

### F. Barrier Film

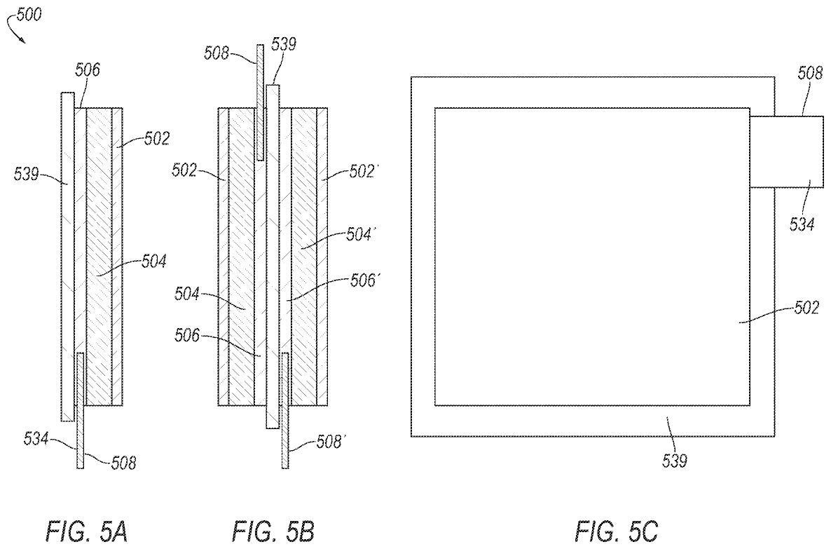

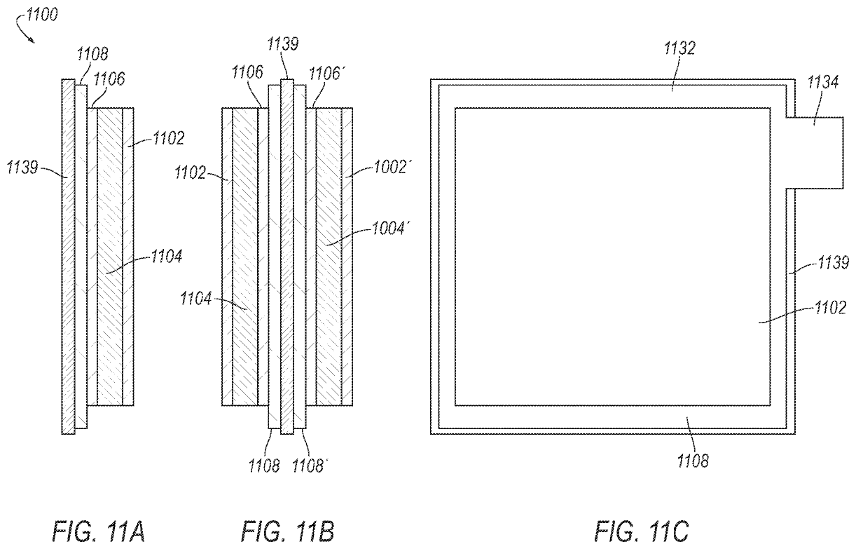

With reference to FIGS. 5A and 11A, the anode assembly may comprise a barrier film 539, 1139. The barrier film electrically separates two or more anode assemblies from each other. The barrier film may comprise any suitable material for electrically separating one anode assembly from another anode assembly. For example, the barrier film may comprise any polymer described herein for the seal layer. In some embodiments, the barrier film comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

In some embodiments, the barrier film 539 is at least partially disposed on the deposited layer 506, as shown in FIG. 5A. In the illustrated embodiment, the barrier film is disposed on an entire surface of the deposited layer. In other embodiments, the barrier film is disposed on only a portion of the deposited layer.

In some embodiments, the barrier film 1139 is at least partially disposed on the anode current collector 1108, as shown in FIG. 11A. In the illustrated embodiment, the barrier film is disposed on an entire surface of the anode current collector. In other embodiments, the barrier film is disposed on only a portion of the anode current collector.

In some embodiments, the barrier film is substantially impervious to liquid. In other embodiments, the barrier film is pervious to liquid.

### G. Other Embodiments

In another aspect, the present invention provides an anode assembly for a battery cell. The anode assembly comprises a separator layer, an anode layer, a deposited layer, and an anode current collector. The anode layer is at least partially disposed on the separator layer and has a first surface facing the separator layer and a second surface facing away from the separator layer. The anode layer comprises a solid-state electrolyte (SSE) material having pores. The deposited layer is at least partially disposed on the second surface of the anode layer. The deposited layer comprises a conductive material and a nucleation material. The anode current collector is coupled to the deposited layer.

In yet another aspect, the present invention provides an anode assembly for a battery cell. The anode assembly comprises a separator layer, an anode layer, an electrically conductive layer, and an anode current collector. The anode layer is at least partially disposed on the separator layer and has a first surface facing the separator layer and a second surface facing away from the separator layer. The anode layer comprises a solid-state electrolyte (SSE) material having pores. The electrically conductive layer is at least partially disposed on the second surface of the anode layer. The electrically conductive layer comprises a conductive material. The anode current collector is coupled to the electrically conductive layer.

In another aspect, the present invention provides an anode assembly for a battery cell. The anode assembly comprises a separator layer, an anode layer, a nucleation layer, and an anode current collector. The anode layer is at least partially disposed on the separator layer and has a first surface facing the separator layer and a second surface facing away from the separator layer. The anode layer comprises a solid-state electrolyte (SSE) material having pores. The nucleation layer is at least partially disposed on the second surface of the anode layer. The nucleation layer comprises a nucleation material. The anode current collector is coupled to the nucleation layer.

In a further aspect, the present invention provides an anode assembly for a battery cell. The anode assembly comprises a separator layer, an anode layer, an electrically conductive layer, a nucleation layer, and an anode current collector. The anode layer is at least partially disposed on the separator layer and has a first surface facing the separator layer and a second surface facing away from the separator layer. The anode layer comprises a solid-state electrolyte (SSE) material having pores. The nucleation layer is at least partially disposed on the second surface of the anode layer. The nucleation layer comprises a nucleation material. The electrically conductive layer is at least partially disposed on a surface of the nucleation layer that faces away from the anode layer. The electrically conductive layer comprises a conductive material. The anode current collector is coupled to the electrically conductive layer.

### III. Multi-Layer Anode Assembly

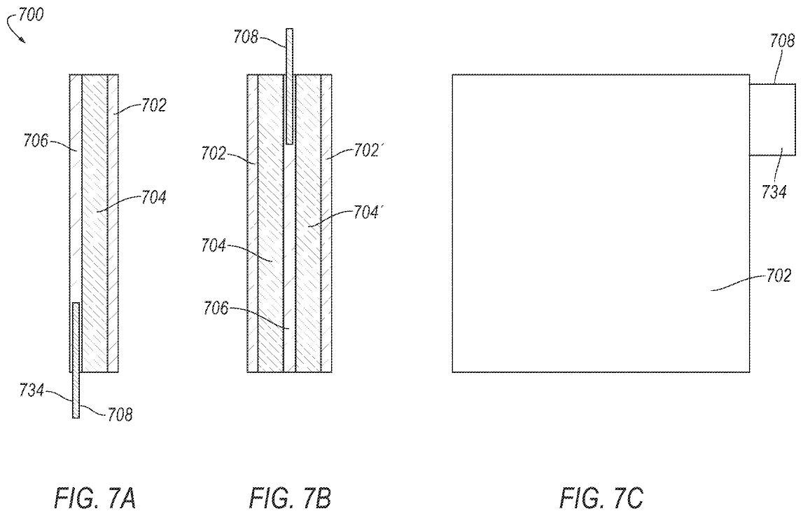

Another aspect of the present provides a multi-layer anode assembly. The multi-layer anode assembly combines two anode assemblies described herein such that at least one component is common to each anode assembly. For example, with reference to FIGS. 1B, 4B, 9B, and 10B, the multi-layer anode assembly may comprise a common anode current collector. In other embodiments, the multi-layer anode assembly comprises a common seal layer, as shown in FIG. 6B. In other embodiments, the multi-layer anode assembly may comprise a common barrier film, as shown in FIGS. 3B, 5B, and 11B. In some embodiments, the multi-layer anode assembly comprises a common deposited layer and anode current collector, as shown in FIG. 7B. And, in some embodiments, the multi-layer anode assembly comprises a common electrically conductive layer and anode current collector, as shown in FIG. 8B.

### IV. Battery Cell

Another aspect of the present invention provides a battery cell. The battery cell comprises an anode assembly and a cathode assembly. The anode assembly may be any anode assembly described herein. The cathode assembly comprises a cathode layer and a cathode current collector.

### A. Cathode Layer

The cathode layer is at least partially disposed on the separator layer of the anode assembly. In some embodiments, the cathode layer is disposed entirely on a surface of the separator layer that faces away from the anode layer. In other embodiments, the cathode layer is disposed only partially on a surface of the separator layer that faces away from the anode layer.

The cathode layer may be comprised of any suitable material. In some embodiments, the cathode layer comprises a lithium ion-conducting material. For example, the lithium ion-conducting material may be lithium nickel manganese cobalt oxides (NMC, LiNiₓMn_{y}Co_{z}O₂, wherein x+y+z=1), such as LiCoO₂, LiNi_{1/3}Co_{1/3}Mn_{1/3}O₂, LiNi_{0.5}Co_{0.2}Mn_{0.3}O₂; lithium manganese oxides (LMOs), such as LiMn₂O₄, LiNi_{0.5}Mn_{1.5}O₄; lithium iron phosphates (LFPs) such as LiFePO₄, LiMnPO₄, and LiCoPO₄, and Li₂MMn₃O₈, wherein M is selected from Fe, Co, or any combination thereof. In some embodiments, the ion-conducting cathode material is a high energy ion-conducting cathode material such as Li₂MMn₃O₈, wherein M is selected from Fe, Co, or any combination thereof.

In some embodiments, the cathode comprises a sodium ion-conducting material. For example, the sodium ion-conducting material may be Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, or any composite material (e.g., composites with carbon black) thereof (e.g., Na_{2/3}Fe_{1/2}Mn_{1/2}O₂@graphene composite).

In some embodiments, the cathode layer comprises a magnesium ion-conducting material. For example, the magnesium ion-conducting material may be doped manganese oxide (e.g., MgₓMnO_{2-y}H₂O).

In some embodiments, the cathode layer comprises an organic sulfide or a polysulfide. For example, the organic sulfide or polysulfide may be carbynepolysulfide and copolymerized sulfur.

In some embodiments, the cathode layer comprises an air electrode. For example, the air electrode may be large surface area carbon particles (e.g., Super P (i.e., a conductive carbon black)) and catalyst particles (e.g., alpha-MnO₂ nanorods) bound in a mesh (e.g., a polymer binder such as PVDF binder).

In some embodiments, the cathode layer has a thickness of from about 1 μm to about 500 μm. In some embodiments, the cathode layer has a thickness of from about 1 μm to about 200 μm. In other embodiments, the cathode layer has a thickness of from about 1 μm to about 100 μm. In some embodiments, the cathode layer has a thickness of from about 1 μm to about 50 μm. In some embodiments, the cathode layer has a thickness of from about 1 μm to about 20 μm. In some embodiments, the cathode layer has a thickness of from about 10 μm to about 150 μm. In other embodiments, the cathode layer has a thickness of from about 40 μm to about 100 μm. And, in some embodiments, the cathode layer has a thickness of from about 60 μm to about 80 μm.

### B. Cathode Current Collector

The cathode current collector is coupled to the cathode layer. In some embodiments, the cathode current collector comprises a metal foil. In such embodiments, the metal foil is at least partially disposed on a surface of the cathode layer that faces away from the separator layer. For example, the metal foil may be disposed on the entire surface of the cathode layer that faces away from the separator layer. And, in some embodiments, the metal foil is only partially disposed on the surface of the cathode layer that faces away from the deposited layer.

In some embodiments, the metal foil has a tab configured to connect with an external circuit. In some embodiments, the tab is integral with the metal foil. In other embodiments, the tab is coupled (e.g., welded) to the metal foil. And, in some embodiments, the cathode current collector comprises a tab configured to connect with an external circuit.

The cathode current collector may be comprised of any suitable material. In some embodiments, the cathode current collector (e.g., the metal foil and/or the tab) comprises aluminum, stainless steel, alloys thereof, or any combination thereof. In some embodiments, the cathode current collector comprises aluminum. In some embodiments, the cathode current collector comprises an aluminum alloy. In other embodiments, the cathode current collector comprises stainless steel. And, in some embodiments, the cathode current collector comprises a stainless steel alloy.

In some embodiments, the cathode current collector comprises a film. For example, the film may comprise a polymer material and a conductive material. The conductive material may be any conductive material described herein. For example, the conductive material may be a metal material. In some embodiments, the conductive material comprises aluminum, stainless steel, alloys thereof, or any combination thereof. In some embodiments, the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof. When the cathode current collector comprises a film, the cathode current collector may be substantially impervious to liquid.

### C. Liquid

In some embodiments, the battery cell comprises a liquid. The liquid comprises an electrolyte, an anolyte, a catholyte, or any combination thereof. In some embodiments, the liquid comprises a lithium salt, a linear carbonate, a cyclic carbonate, an ionic liquid, or any combination thereof. For example, the liquid may comprise a mixture of lithium bis(fluorosulfonyl)imide and N-propyl-N-methylpyrrolidinium bis(fluorosulfonyl)imide. In other embodiments, the liquid comprises or a mixture of lithium hexafluorophosphate, ethylene carbonate, and ethyl methyl carbonate.

### V. Methods of Forming an Anode Assembly

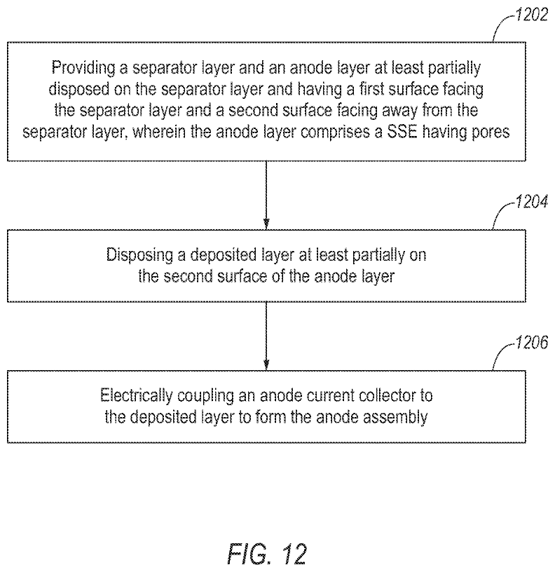

Another aspect of the present invention provides a method of forming an anode assembly. With reference to FIG. 12, a flow chart depicting an exemplary implementation of forming an anode assembly for a battery cell is provided. The method comprises:
(a) providing a separator layer and an anode layer at least partially disposed on the separator layer and having a first surface facing the separator layer and a second surface facing away from the separator layer, wherein the anode layer comprises a SSE having pores (1202);
(b) disposing a deposited layer at least partially on the second surface of the anode layer (1204); and
(c) electrically coupling an anode current collector to the deposited layer to form the anode assembly (1206).

The separator layer may be any separator layer described herein. The anode layer may be any anode layer described herein. The deposited layer may be any deposited layer described herein.

In some implementations, step (b) comprises disposing the deposited layer at least partially on the second surface of the anode layer. For example, the deposited layer may be disposed on the entire second surface of the anode layer. In other implementations, the deposited layer is only partially disposed on the second surface of the anode layer.

In some implementations, step (b) comprises disposing at least one of an electrically conductive layer and a nucleation layer at least partially on the second surface of the anode layer. For example, the at least one of the electrically conductive layer and the nucleation layer may be disposed on the entire second surface of the anode layer. In other implementations, the at least one of the electrically conductive layer and the nucleation layer is disposed only partially on the second surface of the anode layer.

The electrically conductive layer may be any electrically conductive layer described herein. The nucleation layer may be any nucleation layer described herein.

In some implementations, step (b) comprises disposing the electrically conductive layer at least partially on the second surface of the anode layer. For example, the electrically conductive layer may be disposed on the entire second surface of the anode layer. In other implementations, the electrically conductive layer is disposed only partially on the second surface of the anode layer.

In some implementations, step (b) comprises disposing the nucleation layer at least partially on the second surface of the anode layer. For example, the nucleation layer may be disposed on the entire second surface of the anode layer. In other implementations, the nucleation layer is disposed only partially on the second surface of the anode layer.

In some implementations, step (b) comprises disposing the electrically conductive layer and the nucleation layer at least partially on the second surface of the anode layer. For example, the electrically conductive layer is disposed between the anode layer and the nucleation layer. In other implementations, the nucleation layer is disposed between the anode layer and the electrically conductive layer.

In some implementations, step (b) comprises disposing the deposited layer, the electrically conductive layer, and/or the nucleation layer by thermal evaporation, sputtering, electron-beam deposition, molecular beam epitaxy, pulsed laser deposition, plasma-enhanced physical vapor deposition, atomic layer deposition, screen printing, inkjet printing, casting, coating, or any combination thereof. In some implementations, step (b) comprises disposing the deposited layer, the electrically conductive layer, and/or the nucleation layer by thermal evaporation. In other implementations, step (b) comprises disposing the deposited layer, the electrically conductive layer, and/or the nucleation layer by sputtering. In some implementations, step (b) comprises disposing the deposited layer, the electrically conductive layer, and/or the nucleation layer by electron-beam deposition. In some implementations, step (b) comprises disposing the deposited layer, the electrically conductive layer, and/or the nucleation layer by molecular beam epitaxy. In other implementations, step (b) comprises disposing the deposited layer, the electrically conductive layer, and/or the nucleation layer by pulsed laser deposition. In some implementations, step (b) comprises disposing the deposited layer, the electrically conductive layer, and/or the nucleation layer by plasma-enhanced physical vapor deposition. In some implementations, step (b) comprises disposing the deposited layer, the electrically conductive layer, and/or the nucleation layer by atomic layer deposition. In some implementations, step (b) comprises disposing the deposited layer, the electrically conductive layer, and/or the nucleation layer by screen printing. In other implementations, step (b) comprises disposing the deposited layer, the electrically conductive layer, and/or the nucleation layer by inkjet printing. In some implementations, step (b) comprises disposing the deposited layer, the electrically conductive layer, and/or the nucleation layer by casting. And, in some implementations, step (b) comprises disposing the deposited layer, the electrically conductive layer, and/or the nucleation layer by coating.

In some implementations, step (b) further comprises
(b1) disposing at least one of an electrically conductive layer and a nucleation layer at least partially on the second surface of the anode layer; and
(b2) treating the at least one of the electrically conductive layer and the nucleation layer.

In some implementations, step (b2) comprises treating the at least one of the electrically conductive layer and the nucleation layer by annealing, heat treating, melting, or oxidizing the at least one of the electrically conductive layer and the nucleation layer. For example, step (b2) may comprise annealing the at least one of the electrically conductive layer and the nucleation layer. In some implementations, step (b2) comprises heat treating the at least one of the electrically conductive layer and the nucleation layer. In other implementations, step (b2) comprises melting the at least one of the electrically conductive layer and the nucleation layer. And, in some implementations, step (b2) comprises oxidizing the at least one of the electrically conductive layer and the nucleation layer.

In some implementations, step (c) comprises electrically coupling the anode current collector to the deposited layer with electrically conductive tape. In other implementations, step (c) comprises electrically coupling the anode current collector to the at least one of the electrically conductive layer and the nucleation layer with electrically conductive tape.

In some implementations, step (c) comprises electrically coupling the anode current collector to the deposited layer by brazing with a brazing material. In other implementations, step (c) comprises electrically coupling the anode current collector to the at least one of the electrically conductive layer and the nucleation layer by brazing with a brazing material. The brazing material may be any brazing material described herein. For example, the brazing material may comprise silver, gold, aluminum, bismuth, antimony, zinc, indium, copper, phosphorus, nickel, titanium, tungsten, chromium, silicon, vanadium, tantalum, zirconium, alloys thereof, or any combination thereof. In some implementations, the deposited layer, the electrically conductive layer, and/or the nucleation layer serves as a brazing material for the anode current collector.

In some implementations, the method further comprises
(d) disposing a seal layer at least partially on the deposited layer, wherein the seal layer is substantially impervious to liquid.

In some implementations, step (d) comprises disposing a seal layer at least partially on the at least one of the electrically conductive layer and the nucleation layer, wherein the seal layer is substantially impervious to liquid. In some implementations, step (d) comprises disposing a seal layer at least partially on the electrically conductive layer. In other implementations, step (d) comprises disposing a seal layer at least partially on the nucleation layer. And, in some implementations, step (d) comprises disposing a seal layer at least partially on the electrically conductive layer and the nucleation layer.

In some implementations, step (d) further comprises disposing a seal layer at least partially on the deposited layer, the electrically conductive layer, and/or the nucleation layer by cold-pressing, hot-pressing, melting, 3D-printing, or any combination thereof, a polymer at least partially on the deposited layer, the electrically conductive layer, and/or the nucleation layer. For example, step (d) may comprise cold-pressing the polymer at least partially on the deposited layer, the electrically conductive layer, and/or the nucleation layer. In some implementations, step (d) comprises hot-pressing the polymer at least partially on the deposited layer, the electrically conductive layer, and/or the nucleation layer. In other implementations, step (d) comprises melting the polymer at least partially on the deposited layer, the electrically conductive layer, and/or the nucleation layer. And, in some implementations, step (d) comprises 3D-printing the polymer at least partially on the deposited layer, the electrically conductive layer, and/or the nucleation layer.

The polymer may be any polymer as described herein. For example, the polymer may comprise polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

In another aspect, the present invention provides a method of forming an anode assembly. The method comprises:
(a-1) providing a separator layer and an anode layer at least partially disposed on the separator layer and having a first surface facing the separator layer and a second surface facing away from the separator layer, wherein the anode layer comprises a SSE having pores;
(b-1) disposing an electrically conductive layer and a nucleation layer at least partially on the second surface of the anode layer; and
(c-1) electrically coupling an anode current collector to at least one of the electrically conductive layer and the nucleation layer to form the anode assembly.

In yet another aspect, the present invention provides a method of forming an anode assembly. The method comprises:
(a-2) providing a separator layer and an anode layer at least partially disposed on the separator layer and having a first surface facing the separator layer and a second surface facing away from the separator layer, wherein the anode layer comprises a SSE having pores;
(b-2) disposing a nucleation layer at least partially on the second surface of the anode layer;
(c-2) disposing an electrically conductive layer at least partially on a surface of the nucleation layer that faces away from the anode layer and;
(d-2) electrically coupling an anode current collector to the electrically conductive layer to form the anode assembly.

### VI. Examples

In order that the invention described herein may be more fully understood, the following examples are set forth. The examples described in this application are offered to illustrate the methods and anode assemblies provided herein and are not to be construed in any way as limiting their scope.

### Example 1: Silver/Nickel Anode Assembly

A separator layer and an anode layer at least partially disposed on the separator layer and having a first surface facing the separator layer and a second surface facing away from the separator layer was provided. The separator layer and the anode layer measured 1 cm×1 cm. The separator layer comprised a lithium lanthanum zirconium oxide (LLZO) solid-state electrolyte (SSE) material. The anode layer comprised a LLZO SSE material. The pores of the anode layer were substantially free of a metal material, such as lithium metal.

The separator layer and the anode layer were placed into an apparatus with a 7.2 mm×7.2 mm square window on the bottom. The separator layer and the anode layer were placed into the apparatus such that a deposited layer would be disposed on the anode layer by a line-of-sight, thermal evaporation process with a Metra thermal evaporator. The deposited layer was disposed only on the anode layer in the area of the 7.2 mm×7.2 mm window, leaving a 1.4-mm border of the anode layer free of the deposited layer around the edge of the deposited layer.

From a resting state under vacuum, an evaporation chamber of the thermal evaporator was vented to bring it to atmospheric pressure. One electrically conductive boat was loaded with silver pellets and another electrically conductive boat was loaded with nickel pellets. Each electrically conductive boat was then connected to electrical posts in the evaporation chamber. The apparatus containing the separator layer and the anode layer was loaded into the evaporation chamber above the electrically conductive boats with the anode layer facing the boats. The chamber was then pumped down to less than 3×10⁻⁶ Torr with a roughing pump and a turbo pump. The electrically conductive boat containing silver was heated by increasing the current passing through the boat until the silver melted. Once the silver melted, a shutter was opened that allowed the silver to evaporate and deposit on the anode layer. Once a desired thickness was achieved (~100 nm, as measured by the quartz crystal), the shutter was closed and the silver was cooled. After the silver was disposed on the anode layer, the boat containing nickel was heated by increasing the current until the nickel melted. Once the nickel melted, the shutter was again opened, allowing the nickel to evaporate and deposit on the silver that was previously deposited on the anode layer. Once the desired thickness was achieved (~400 nm), the shutter was closed and the current was reduced to cool the nickel. Once cooled, the chamber was vented and the apparatus containing the separator layer and the anode layer was removed from the thermal evaporator.

The anode assembly was completed in an argon-filled glove box using electrically conductive adhesive transfer tape having a high adhesion side, a low adhesion side, and isotropic XYZ-axis electrical connectivity (sourced from 3M™) to attach a copper foil anode current collector to the deposited layer. The electrically conductive tape was double-sided and pressed onto the copper foil first. Then, the electrically conductive tape was pressed onto the deposited layer to form the anode assembly. The edges of the anode layer were sealed with a polymer via a melt process, forming a sealed anode assembly. A nickel tab was welded to the metal foil of the anode current collector to complete the sealed anode assembly.

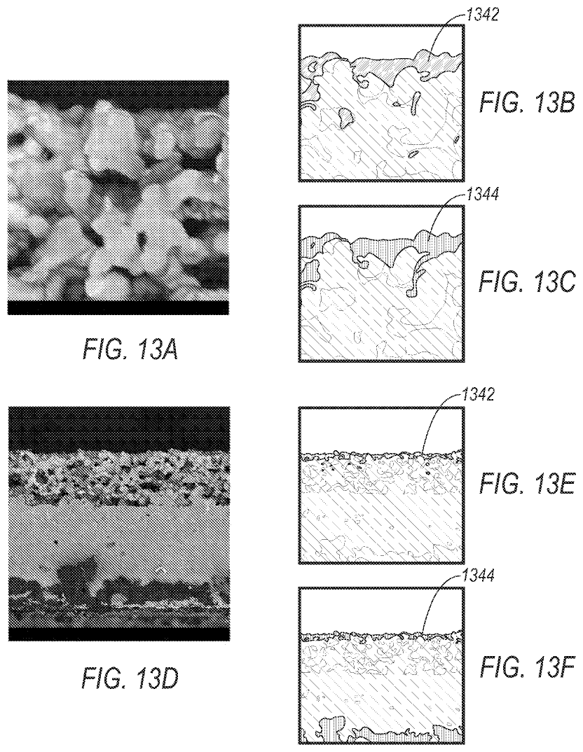

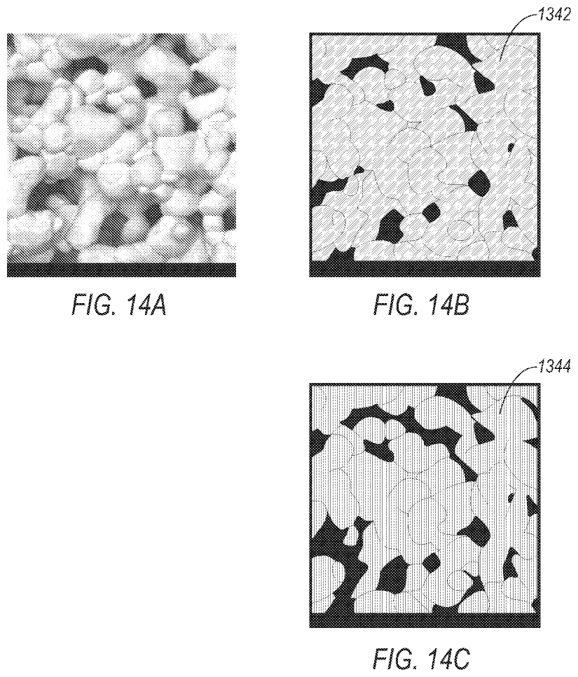

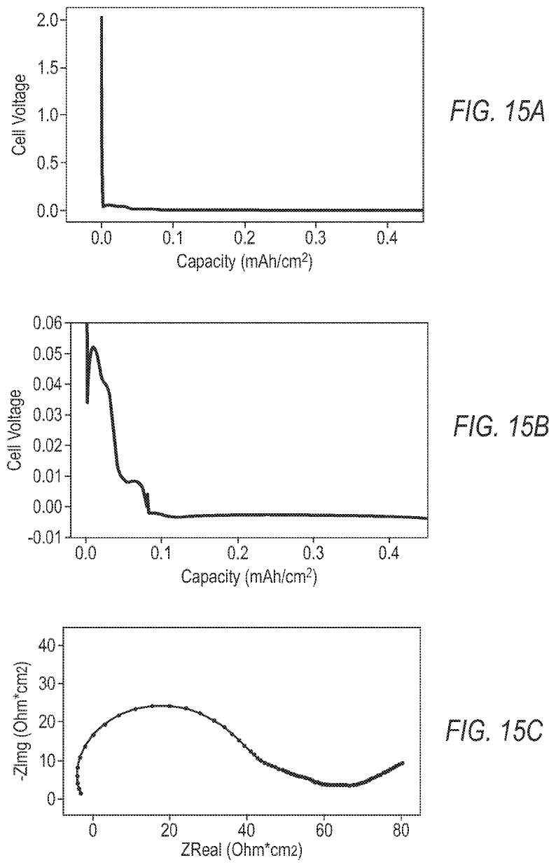

Scanning electron microscope (SEM) images of the nickel layer 1342 and the silver layer 1344 are shown in FIGS. 13A-13F and 14A-14C. FIGS. 15A and 15B show a cyclic voltage profile for the anode assembly (working electrode/separator) and a lithium metal reference electrode. The cycling was set at 20 μA/cm² relative to the area of the silver and nickel layers. As shown in FIG. 15C, impedance was measured after 8 hours of cathodic current density at 20 μA/cm² in the frequency range of 2 MHz-1 Hz. The open-circuit potential of the cell after assembly was 2.02 V.

### Example 2: Battery Cell

A cathode assembly was prepared with a cathode layer comprising a lithium nickel manganese cobalt oxide (NMC) and a cathode current collector comprising an aluminum metal foil. An aluminum tab was welded to the aluminum metal foil of the cathode current collector.

The cathode layer was pressed against the separator layer of the anode assembly and integrated into an aluminum foil/polypropylene pouch. The cathode layer was wetted with a liquid catholyte. The pouch was sealed under vacuum conditions via an impulse/heat sealing process to complete the battery cell.

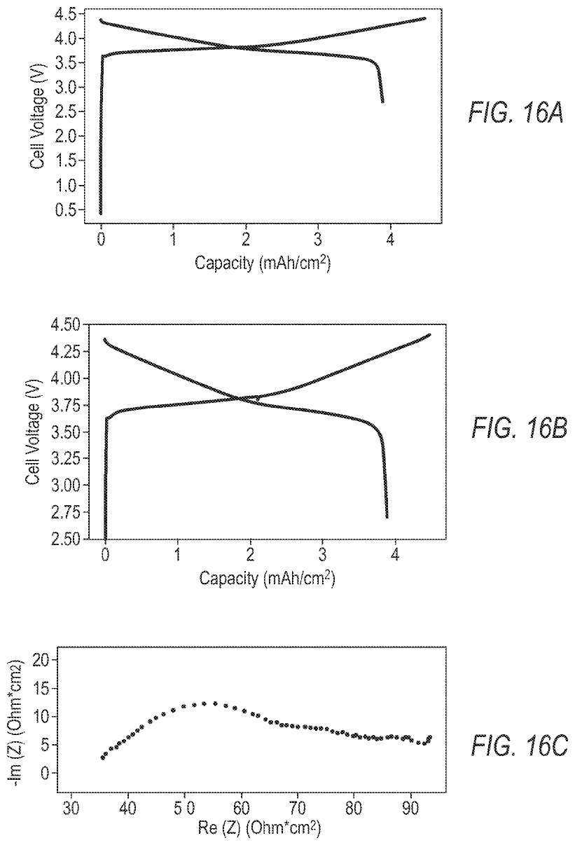

FIGS. 16A and 16B show a cyclic voltage profile for the battery cell. The cycling was set at 180 μA/cm² relative to the area of the cathode layer. As shown in FIG. 16C, impedance was measured after 12 hours of first-cycle charge at 180 μA/cm² in the frequency range of 10 kHz-0.1 Hz. The open-circuit potential of the cell after assembly was 0.38 V.

### Example 3: Copper/Indium Anode Assembly

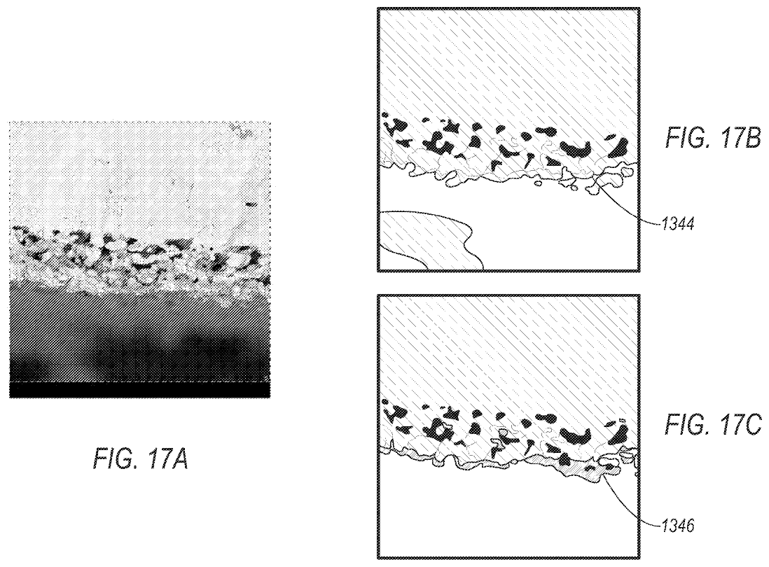

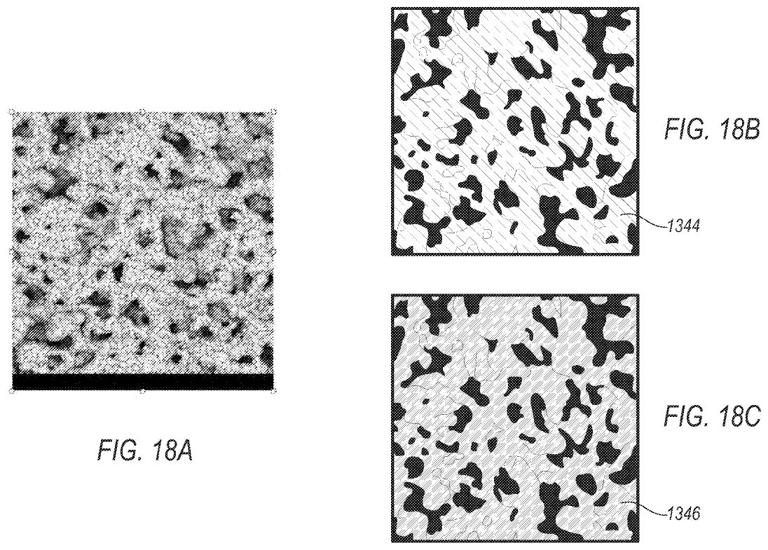

The anode assembly of Example 3 was prepared according to a procedure substantially similar to the procedure set forth in Example 1 except that a ~3.2 μm layer of copper was first deposited on the anode layer followed by a ~800 nm layer of indium. SEM images of the copper layer 1344 and the indium layer 1346 are shown in FIGS. 17A-17C and 18A-18C.

### Example 4: Copper Anode Assembly

The anode assembly of Example 4 was prepared according to a procedure substantially similar to the procedure set forth in Example 1 except Cuprum 81 (CuNex series sinter paste from Schlenk) was painted on the anode layer followed by attachment of a copper current collector and anode sealing.

The Cuprum 81 was mixed in a planetary mixer for 5 mins at 500 rpm and applied in excess to the porous surface of the anode layer using a thin bristle paintbrush (size=000). While the Cuprum 81 was wet, the excess was carefully removed with a squeegee to provide a substantially even layer having a thickness between 5-8 μm.

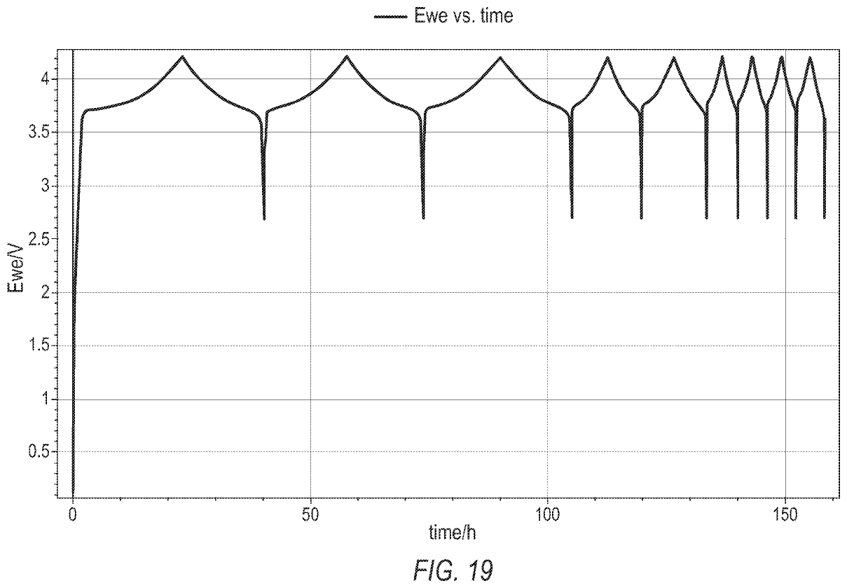

The treated porous anode layer was dried under hot air (~100° C.) applied evenly across the entire surface for ~5 min to evaporate solvents before sintering. The dried copper-treated anode layer and separator layer were placed in a box furnace (treatment side up) in an inert environment (argon, nitrogen) with no external pressure applied and sintered at a temperature of 500-700° C. for ~2 hrs using a heat ramp of 30° C./min. The furnace was cooled (30° C./min) to room temperature, and the sintered copper-treated anode layer and separator layer were removed from the furnace and placed onto a copper current collector wherein the copper-treated surface of the anode layer was physically attached to the copper current collector by contact with the current collector. The copper anode assembly was completed by anode sealing according to Example 1 and integrated into a test cell according to Example 2. FIG. 19 shows voltage as a function of time during cell cycling (i.e., charging and discharging), wherein the test cell was charged and discharged at a current of (a) C/10 for cycles 1-3, (b) a current of C/5 for cycles 4 and 5, and (c) a current of C/2 for cycles 6-9.

### Example 5: Graphene Anode Assembly

The anode assembly of Example 5 was prepared according to a procedure substantially similar to the procedure set forth in Example 1 except graphene in DMF (0.2 mg/mL) was deposited on the anode layer followed by attachment of a copper current collector and anode sealing.

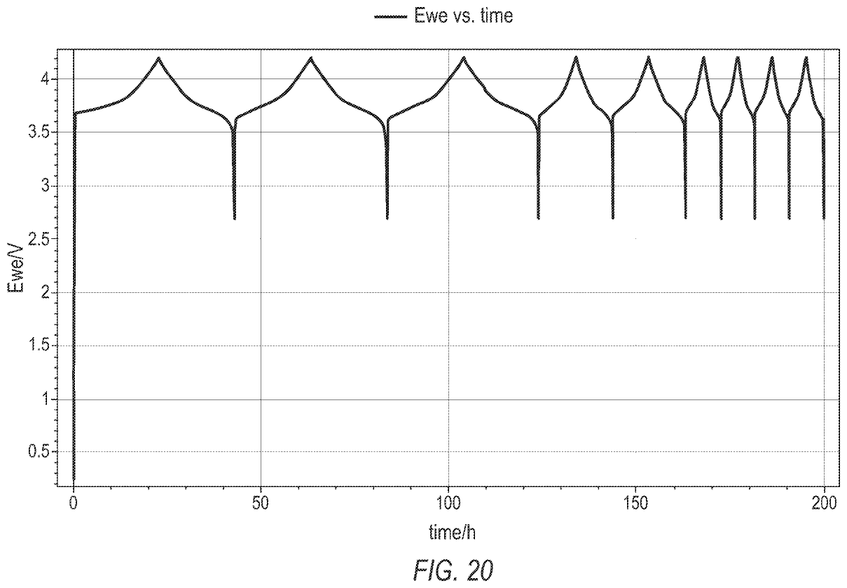

A solution of graphene in DMF (0.2 mg/mL) (Sigma Aldrich) was placed under 3 Å molecular sieves for at least 2 weeks. The filtrate was decanted and vortexed for ~5 min with a benchtop vortex mixer prior to use. 30 μl of the resulting solution was drop cast onto the center of the porous side of the anode layer using a micropipette. The treated anode layer was dried at 140° C. for ~10 min to remove the DMF, and the work piece was then heated at 200° C. for ~30 min to anneal the deposited graphene. The anode assembly was sintered, attached to a copper current collector, and sealed according to Example 4. The sealed anode assembly was integrated into a test cell according to Example 2 which underwent charge cycling. FIG. 20 shows voltage as a function of time during cell cycling (i.e., charging and discharging), wherein the test cell was charged and discharged at a current of (a) C/10 for cycles 1-3, (b) a current of C/5 for cycles 4 and 5, and (c) a current of C/2 for cycles 6-9.

### EQUIVALENTS AND SCOPE

In the claims articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

Furthermore, the invention encompasses all variations, combinations, and permutations in which one or more limitations, elements, clauses, and descriptive terms from one or more of the listed claims is introduced into another claim. For example, any claim that is dependent on another claim can be modified to include one or more limitations found in any other claim that is dependent on the same base claim. Where elements are presented as lists, e.g., in Markush group format, each subgroup of the elements is also disclosed, and any element(s) can be removed from the group. It should it be understood that, in general, where the invention, or aspects of the invention, is/are referred to as comprising particular elements and/or features, certain embodiments of the invention or aspects of the invention consist, or consist essentially of, such elements and/or features. For purposes of simplicity, those embodiments have not been specifically set forth in haec verba herein. It is also noted that the terms “comprising” and “containing” are intended to be open and permits the inclusion of additional elements or steps. Where ranges are given, endpoints are included. Furthermore, unless otherwise indicated or otherwise evident from the context and understanding of one of ordinary skill in the art, values that are expressed as ranges can assume any specific value or sub-range within the stated ranges in different embodiments of the invention, to the tenth of the unit of the lower limit of the range, unless the context clearly dictates otherwise.

This application refers to various issued patents, published patent applications, journal articles, and other publications, all of which are incorporated herein by reference. If there is a conflict between any of the incorporated references and the instant specification, the specification shall control. In addition, any particular embodiment of the present invention that falls within the prior art may be explicitly excluded from any one or more of the claims. Because such embodiments are deemed to be known to one of ordinary skill in the art, they may be excluded even if the exclusion is not set forth explicitly herein. Any particular embodiment of the invention can be excluded from any claim, for any reason, whether or not related to the existence of prior art.

Those skilled in the art will recognize or be able to ascertain using no more than routine experimentation many equivalents to the specific embodiments described herein. The scope of the present embodiments described herein is not intended to be limited to the above Description, but rather is as set forth in the appended claims. Those of ordinary skill in the art will appreciate that various changes and modifications to this description may be made without departing from the spirit or scope of the present invention, as defined in the following claims.

1-70. (canceled)

71. An anode assembly for a battery cell, comprising:
a separator layer;
an anode layer at least partially disposed on the separator layer and having a first surface facing the separator layer and a second surface facing away from the separator layer, wherein the anode layer comprises a solid-state electrolyte (SSE) material having pores;
a deposited layer at least partially disposed on the second surface of the anode layer and comprising at least one of a conductive material and a nucleation material; and
an anode current collector coupled to the deposited layer.

72. The anode assembly of claim 71, wherein the deposited layer comprises at least one of
an electrically conductive layer at least partially disposed on the second surface of the anode layer and comprising the conductive material; and
a nucleation layer at least partially disposed on the second surface of the anode layer and comprising the nucleation material;
wherein the anode current collector is coupled to the at least one of the electrically conductive layer and the nucleation layer.

73. The anode assembly of claim 72, wherein the deposited layer comprises the electrically conductive layer.

74. The anode assembly of claim 73, wherein the conductive material of the electrically conductive layer comprises a metal, a metal oxide, a metal alloy, carbon black, carbon nanotubes, graphite, graphene, amorphous carbon, or any combination thereof.

75. The anode assembly of claim 74, wherein the conductive material of the electrically conductive layer comprises copper, nickel, titanium, stainless steel, alloys thereof, or any combination thereof.

76. The anode assembly of claim 73, wherein the electrically conductive layer has a thickness of from about 1 nm to about 15 μm.

77. The anode assembly of claim 72, wherein the deposited layer comprises the nucleation layer.

78. The anode assembly of claim 77, wherein the nucleation material of the nucleation layer comprises silver, gold, aluminum, bismuth, antimony, indium, zinc, gallium, nickel oxide, titanium oxide, copper oxide, zinc oxide, graphene, graphite, carbon black, or any combination thereof.

79. The anode assembly of claim 77, wherein the nucleation layer has a thickness of from about 1 nm to about 1 μm.

80. The anode assembly of claim 72, wherein the deposited layer comprises the electrically conductive layer and the nucleation layer.

81. The anode assembly of claim 80, wherein the nucleation layer is disposed between the anode layer and the electrically conductive layer.

82. The anode assembly of claim 81, wherein the electrically conductive layer is disposed between the anode layer and the nucleation layer.

83. The anode assembly of claim 82, wherein the conductive material of the electrically conductive layer comprises a metal, a metal oxide, a metal alloy, carbon black, carbon nanotubes, graphite, graphene, amorphous carbon, or any combination thereof.

84. The anode assembly of claim 83, wherein the conductive material of the electrically conductive layer comprises copper, nickel, titanium, stainless steel, alloys thereof, or any combination thereof.

85. The anode assembly of claim 84, wherein the electrically conductive layer has a thickness of from about 1 nm to about 15 μm.

86. The anode assembly of claim 85, wherein the nucleation material of the nucleation layer comprises silver, gold, aluminum, bismuth, antimony, indium, zinc, gallium, nickel oxide, titanium oxide, copper oxide, zinc oxide, graphene, graphite, carbon black, or any combination thereof.

87. The anode assembly of claim 86, wherein the nucleation layer has a thickness of from about 1 nm to about 1 m.

88. The anode assembly of claim 81, wherein the electrically conductive layer, the nucleation layer, or both layers are substantially impervious to liquid.

89. The anode assembly of claim 88, wherein the anode assembly further comprises a seal layer at least partially disposed on the at least one of the electrically conductive layer and the nucleation layer, wherein the seal layer is substantially impervious to liquid.

90. The anode assembly of claim 89, wherein the seal layer comprises a polymer, wherein the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

91. The anode assembly of claim 90, wherein the seal layer has a thickness of from about 1 μm to about 50 μm.

92. The anode assembly of claim 72, wherein electrically conductive tape couples the anode current collector to the at least one of the electrically conductive layer and the nucleation layer.

93. The anode assembly of claim 72, wherein the electrically conductive layer is further defined as a first electrically conductive layer, wherein the anode assembly further comprises a second electrically conductive layer at least partially disposed on the first electrically conductive layer, and wherein the second electrically conductive layer comprises a conductive material.

94. The anode assembly of claim 92, wherein the separator layer is substantially free of pores.

95. The anode assembly of claim 94, wherein the separator layer comprises a SSE material.

96. The anode assembly of claim 95, wherein the SSE material of the separator layer comprises a polymer, a sulfide, an oxide, a chalcogenide, or any combination thereof.

97. The anode assembly of claim 96, wherein the separator layer has a thickness of from about 1 m to about 300 m.

98. The anode assembly of claim 72, wherein the pores of the anode layer are substantially free of a lithium material.

99. The anode assembly of claim 98, wherein the lithium material comprises lithium metal.

100. The anode assembly of claim 99, wherein the anode layer defines a first porous region between the first and second surfaces of the anode layer and a second porous region between the first porous region and the second surface of the anode layer.

101. The anode assembly of claim 100, wherein the pores of the first porous region are substantially free of a metal material.

102. The anode assembly of claim 101, wherein the pores of the first porous region are substantially free of a lithium material.

103. The anode assembly of claim 102, wherein the lithium material comprises lithium metal.

104. The anode assembly of any one of claim 100, wherein at least a portion of the pores of the second porous region comprise a conductive material, a nucleation material, or any combination thereof.

105. The anode assembly of claim 104, wherein the conductive material of the second porous region comprises a metal, a metal oxide, a metal alloy, carbon black, carbon nanotubes, graphite, graphene, amorphous carbon, or any combination thereof.

106. The anode assembly of claim 105, wherein the nucleation material of the second porous region comprises silver, gold, aluminum, bismuth, antimony, indium, zinc, gallium, nickel oxide, titanium oxide, copper oxide, zinc oxide, carbon black, graphene, graphite, or any combination thereof.

107. The anode assembly of any one of claim 106, wherein the anode layer has a thickness of from about 1 μm to about 500 μm.

108. The anode assembly of any one of claim 72, wherein the anode current collector comprises a metal foil.

109. The anode assembly of claim 108, wherein the metal foil comprises copper, nickel, titanium, stainless steel, alloys thereof, or any combination thereof.

110. The anode assembly of claim 109, wherein the metal foil has a tab configured to connect with an external circuit.

111. The anode assembly of claim 72, wherein the deposited layer is substantially impervious to liquid.

112. The anode assembly of claim 72, wherein the anode assembly further comprises a seal layer at least partially disposed on the deposited layer, wherein the seal layer is substantially impervious to liquid.

113. The anode assembly of 112, wherein the seal layer comprises a polymer.

114. The anode assembly of claim 113, wherein the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.

115. The anode assembly of claim 114, wherein the seal layer has a thickness of from about 1 μm to about 50 μm.

116. The anode assembly of claim 115, wherein the seal layer couples the anode current collector to the deposited layer.

117. The anode assembly of claim 72, wherein electrically conductive tape couples the anode current collector to the deposited layer.

118. A battery cell, comprising:
the anode assembly of claim 72; and
a cathode assembly comprising,
a cathode layer at least partially disposed on the separator layer of the anode assembly; and
a cathode current collector coupled to the cathode layer.

119. The battery cell of claim 118, wherein the battery cell further comprises a liquid comprising an electrolyte, an anolyte, a catholyte, or any combination thereof.

120. The battery cell of claim 119, wherein the liquid comprises a lithium salt, a linear carbonate, a cyclic carbonate, an ionic liquid, or any combination thereof.

121. A method of forming an anode assembly, comprising:
(a) providing a separator layer and an anode layer at least partially disposed on the separator layer and having a first surface facing the separator layer and a second surface facing away from the separator layer, wherein the anode layer comprises a solid-state electrolyte (SSE) having pores;
(b) disposing at least one of an electrically conductive layer and a nucleation layer at least partially on the second surface of the anode layer; and
(c) electrically coupling an anode current collector to the at least one of the electrically conductive layer and the nucleation layer to form the anode assembly.

122. The method of claim 121, wherein step (b) comprises disposing the electrically conductive layer at least partially on the second surface of the anode layer.

123. The method of claim 122, wherein step (b) comprises disposing the nucleation layer at least partially on the second surface of the anode layer.

124. The method of claim 123, wherein step (b) comprises disposing the electrically conductive layer and the nucleation layer at least partially on the second surface of the anode layer.

125. The method of claim 124, wherein the electrically conductive layer is disposed between the anode layer and the nucleation layer.

126. The method of claim 125, wherein the nucleation layer is disposed between the anode layer and the electrically conductive layer.

127. The method of claim 126, wherein step (b) comprises disposing the at least one of the electrically conductive layer and the nucleation layer by thermal evaporation, sputtering, electron-beam deposition, molecular beam epitaxy, pulsed laser deposition, plasma-enhanced physical vapor deposition, atomic layer deposition, screen printing, inkjet printing, casting, coating, or any combination thereof.

128. The method of claim 121, wherein step (b) further comprises
(b1) disposing at least one of an electrically conductive layer and a nucleation layer at least partially on the second surface of the anode layer; and
(b2) treating the at least one of the electrically conductive layer and the nucleation layer.

129. The method of claim 128, wherein step (b2) further comprises treating the at least one of the electrically conductive layer and the nucleation layer by annealing, heat treating, melting, or oxidizing the at least one of the electrically conductive layer and the nucleation layer.

130. The method of claim 121, wherein step (c) comprises electrically coupling the anode current collector to the at least one of the electrically conductive layer and the nucleation layer with electrically conductive tape.

131. The method of claim 121, wherein step (c) comprises electrically coupling the anode current collector to the at least one of the electrically conductive layer and the nucleation layer by brazing with a brazing material, wherein the brazing material comprises silver, gold, aluminum, bismuth, antimony, zinc, indium, copper, phosphorus, nickel, titanium, tungsten, chromium, silicon, vanadium, tantalum, zirconium, alloys thereof, or any combination thereof.

132. The method of claim 123, wherein the method further comprises
(d) disposing a seal layer at least partially on the at least one of the electrically conductive layer and the nucleation layer, wherein the seal layer is substantially impervious to liquid.

133. The method of claim 132, wherein step (d) further comprises disposing a seal layer at least partially on the at least one of the electrically conductive layer and the nucleation layer by cold-pressing, hot-pressing, melting, 3D-printing, or any combination thereof, a polymer at least partially on the at least one of the electrically conductive layer and the nucleation layer.

134. The method of claim 133, wherein the polymer comprises polypropylene, polyethylene, polymethylpentene, polybutene-1, ethylene-octene copolymers, propylene-butane copolymers, polyisobutylene, poly(α-olefin), ethylene propylene rubber, ethylene propylene diene monomer rubber, ethylene-vinyl acetate, ethylene-acrylate copolymers, polyamides, polyesters, polyurethanes, styrene block copolymers, polycaprolactone, polyimide, polyvinyl chloride, polycarbonates, polyacrylates, polymethacrylates, fluoropolymers, epoxy resins, epoxy polymers, silicone rubber, or any combination thereof.
